(19) United States
(12) Patent Application Publication
(10) Pub. No.: US 2007/0147780 A1
(43) Pub. Date: Jun. 28, 2007

(54) Recorder and recording method

(75) Inventors: Masataka Moteki, Tokyo (JP); Takahisa Mori, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/641,776

(22) Filed: Dec. 20, 2006

(30) Foreign Application Priority Data
Dec. 26, 2005 (JP) 2005-372757

(51) Int. Cl. H04N 7/00

(52) U.S. Cl. 386/95

(57) ABSTRACT

According to one embodiment, a recorder comprises: a first area generation unit configured to generate a first recording area used for recording first data in the storage medium; a second area generation unit configured to generate a second recording area in the storage medium, the second recording area used for repeatedly recording in an overwriting manner only second data, the second data being different from the first data and taken as an object of playback for a predetermined period; a management information managing unit configured to record a management information file having management information about first data recorded in the first recording area in the storage medium; and a management information edition unit configured to add management information about the second data into the management information file to allow the second data not to be overwritten, and record the management information into the storage medium.

### CROSS-REFERENCE TO RELATED APPLICATIONS

This application is based upon and claims the benefit of priority from Japanese Patent Application No. 2005-372757, filed on Dec. 26, 2005, the entire contents of which are incorporated herein by reference.

### BACKGROUND

1. Field

One embodiment of the present invention relates to a recorder and a recording method for recording data, for example, a hard disk video recorder.

2. Description of the Related Art

In the field of a video recorder utilizing a large mass storage medium such as a hard disk drive, a recording method called loop recording has been under development. Here, loop recording is a recording method, wherein a fixed region is ensured separately from an ordinary region for recording purpose and overwrite recording is repeatedly performed within the fixed region independently of ordinary recording. Loop recording is limited in terms of a recording time, but enables recording without making a user conscious of a remaining recording time of the storage medium. For instance, loop recording enables realization of a way to temporarily retain a program that is being watched by the user when the user leaves in the middle of watching the program and to resume watching of the program from the scene where the user's leaving has interrupted the user's viewing. A technique of ensuring an area used for repeatedly recording sound data is disclosed in JP-A-10-069300 as a technique related to loop recording.

When loop recording is started in accordance with the user's operation, recording of a program into an area for loop recording begins. As recording of the program proceeds to the end point of the area, recording continues from the start point of the area. Consequently, the user cannot individually manage and play back the data recorded through loop recording. When loop recording is performed repeatedly, the data previously recorded through loop recording are overwritten. Therefore, in order to permanently store the data recorded through loop recording, the data must be copied from the area for loop recording to the area for normal recording.

As mentioned above, the recorder and the recording method described above are inability to individually manage or play back the data recorded through loop recording to thereby overwrite old data.

### BRIEF DESCRIPTION OF THE SEVERAL VIES OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of a recorder of a first embodiment of the present invention;

FIG. 2A is an exemplary schematic diagram showing the overview of a data configuration in the recorder of the first embodiment;

FIG. 2B is an exemplary schematic diagram showing the overview of a data configuration in the recorder of the first embodiment;

FIG. 3 is an exemplary block diagram showing the configuration of a recording management information control section shown in FIG. 1;

FIG. 4 is an exemplary flowchart showing operation of the recorder of the first embodiment;

FIG. 5A is an exemplary schematic diagram showing recording operation performed during normal recording in the first embodiment;

FIG. 5B is an exemplary schematic diagram showing recording operation performed during normal recording in the first embodiment;

FIG. 5C is an exemplary schematic diagram showing recording operation performed during normal recording in the first embodiment;

FIG. 6A is an exemplary schematic diagram showing recording operation performed during loop recording in the first embodiment;

FIG. 6B is an exemplary schematic diagram showing recording operation performed during loop recording in the first embodiment;

FIG. 6C is an exemplary schematic diagram showing recording operation performed during loop recording in the first embodiment;

FIG. 7 is an exemplary block diagram showing the configuration of a recording management information control section of a recorder according to a second embodiment of the present invention;

FIG. 8 is an exemplary flowchart showing operation of the recorder of the second embodiment;

FIG. 9A is an exemplary schematic diagram showing recording operation performed during loop recording in the second embodiment;

FIG. 9B is an exemplary schematic diagram showing recording operation performed during loop recording in the second embodiment;

FIG. 9C is an exemplary schematic diagram showing recording operation performed during loop recording in the second embodiment;

FIG. 9D is an exemplary schematic diagram showing recording operation performed during loop recording in the second embodiment;

FIG. 9E is an exemplary schematic diagram showing recording operation performed during loop recording in the second embodiment;

FIG. 10 is an exemplary block diagram showing the configuration of a recording management information control section of a recorder according to a third embodiment of the present invention;

FIG. 11 is an exemplary flowchart showing operation of the recorder of the third embodiment;

FIG. 12A is an exemplary schematic diagram showing recording operation performed during loop recording in the third embodiment;

FIG. 12B is an exemplary schematic diagram showing recording operation performed during loop recording in the third embodiment;

FIG. 13 is an exemplary block diagram showing the configuration of a recording management information control section of a recorder according to a fourth embodiment of the present invention;

FIG. 14 is an exemplary flowchart showing operation of the recorder of the fourth embodiment;

FIG. 15A is an exemplary schematic diagram showing recording operation performed during loop recording in the fourth embodiment;

FIG. 15B is an exemplary schematic diagram showing recording operation performed during loop recording in the fourth embodiment;

FIG. 16 is an exemplary block diagram showing the configuration of a recording management information control section of a recorder according to a fifth embodiment of the present invention;

FIG. 17 is an exemplary flowchart showing operation of the recorder of the fifth embodiment;

FIG. 18A is an exemplary schematic diagram showing recording operation performed during normal recording in the fifth embodiment;

FIG. 18B is an exemplary schematic diagram showing recording operation performed during normal recording in the fifth embodiment;

FIG. 18C is an exemplary schematic diagram showing recording operation performed during normal recording in the fifth embodiment;

FIG. 19A is an exemplary schematic diagram showing recording operation performed during loop recording in the fifth embodiment;

FIG. 19B is an exemplary schematic diagram showing recording operation performed during loop recording in the fifth embodiment;

FIG. 19C is an exemplary schematic diagram showing recording operation performed during loop recording in the fifth embodiment;

FIG. 20 is an exemplary block diagram showing the configuration of a recording management information control section of a recorder according to a sixth embodiment of the present invention;

FIG. 21 is an exemplary flowchart showing operation of the recorder of the sixth embodiment;

FIG. 22A is an exemplary schematic diagram showing recording operation performed during loop recording in the sixth embodiment;

FIG. 22B is an exemplary schematic diagram showing recording operation performed during loop recording in the sixth embodiment;

FIG. 22C is an exemplary schematic diagram showing recording operation performed during loop recording in the sixth embodiment;

FIG. 22D is an exemplary schematic diagram showing recording operation performed during loop recording in the sixth embodiment; and

FIG. 22E is an exemplary schematic diagram showing recording operation performed during loop recording in the sixth embodiment.

### DETAILED DESCRIPTION

Various embodiments according to the invention will be described hereinafter with reference to the accompanying drawings.

In general, according to one embodiment of the invention, a recorder to record data into a storage medium, comprises: a first area generation unit configured to generate a first recording area used for recording first data in the storage medium; a second area generation unit configured to generate a second recording area in the storage medium, the second recording area used for repeatedly recording in an overwriting manner only second data, the second data being different from the first data and taken as an object of playback for a predetermined period; a management information managing unit configured to record a management information file having management information about first data recorded in the first recording area in the storage medium; and a management information edition unit configured to add management information about the second data into the management information file to allow the second data not to be overwritten in accordance with an instruction for storing the second data recorded in the second recording area, and record the management information into the storage medium.

Further, according to one embodiment of the invention, a recorder comprises: a first recording unit including a first recording area used for recording first data and a second recording area used for repeatedly overwriting only second data being different from the first data and are taken as an object of playback for a predetermined period; a second recording unit recording a management information file including management information about the first data recorded in the first recording area; a third recording unit recording the second data into the second recording area and performing continuous recording of the second data from the starting point of the second recording area when the second data are recorded to the end point of the second recording area; and a management information edition unit configured to add the management information about the second data into the management information file to allow the second data not to be recorded in an overwriting manner, in accordance with an instruction for storing the second data recorded in the second recording area.

Moreover, according to one embodiment of the invention, a recording method comprises: recording into a predetermined recording area of a storage medium data taken as an object of playback for a predetermined period; continuing recording of the data from a starting point of the predetermined recording area when recording has been performed up to an end point of the predetermined recording area; setting management information to manage the recorded data as storage data, in accordance with a storage instruction for storing the recorded data; and recording the data taken as the object of playback for a predetermined period into an area other than the area where the data for storage purpose are recorded.

As described above, data recorded through loop recording and data recorded through normal recording can be managed commonly.

A video recorder (a recorder) or a television set having a so-called loop recording function enables playback of the TV program from the scene where the user's watching of the program has been interrupted, when the user performs operation for starting loop recording at the time of leaving in the middle of watching a TV program, and then performs start operation such as “Time-Shift Playback Operation” at the time of resuming watching the TV program.

Meanwhile, a conceivable mode is to automatically carry out loop recording without causing the user to become conscious about start of loop recording, rather than the user intentionally starting loop recording. For instance, there is a mode where, in such a case where the video recorder is built into a TV set, loop recording is automatically started when the power of the TV set is turned on. In such a case, a possible way to use the function comprises re-displaying scenes which precede the currently-being watched scene, so that the user reaffirms, e.g., contents of the program in which the user is interested, or a mail address where an application for lottery is to be sent.

Loop recording is not limited solely to the way to simply play back a program so that the user can watch the program, but can also be expanded to recording functions provided below.

In many cases, recording is usually programmed after contents of a program have been ascertained in advance. However, recording is not limited solely to such a case. For instance, it is not rare that the user does not perform operation for recording a certain TV program till the user watches the program and knows the contents thereof. At that time, recording is started from a midpoint of the TV program that is being watched. It is natural for the user to think that it would be convenient if scenes of the TV program preceding the scene where recording has been started were recorded. In such a case, scenes subsequent to the scene where the user has performed operation for starting recording operation as well as the scenes automatically, previously recorded without the user's particular consciousness are stored, whereby the TV program watched by the user can be stored prior to the start of recording operation. In some cases, even in the case of a program whose recording operation has been started in midstream, the entirety of the program can be stored from the beginning.

As a matter of course, in the case of a program which is watched by the user without planning to do so in advance, there is no necessity for recording the program. For this reason, in the recording process automatically performed without involvement of the user's consciousness, the loop recording takes a form of retaining recording for a certain period of time and discarding scenes which precede the recorded scenes.

As described above, the recording mode called loop recording includes: recording intended for temporarily retaining the TV program that is being watched; and recording intended for playing back the contents stored by the user to watch. The former recording includes storing the contents recorded through loop recording and playing back the contents later, and hence has a low priority level. In contrast, the latter recording becomes high in terms of priority in storing the contents recorded through loop recording.

During loop recording, overwrite recording is iterated within the fixedly ensured area. Hence, no consideration is paid to storage and playback of contents recorded as in the case of ordinary recording. Further, loop recording is performed independently of ordinary recording. Hence, there is not provided a mechanism for comprehensively managing ordinary recorded contents and loop-recorded contents.

However, when the loop recording is used for implementing the loop recording of the latter mode, in order to comprehensively play back to watch the contents acquired before and after the user performs recording operation, there must be performed processing for internally dubbing, e.g., the contents recorded through loop recording, after loop recording has been completed in association with initiation of ordinary recording performed by the user's operation to convert the loop-recorded contents into contents recorded through ordinary recording operation. Dubbing operation is amere operation for copying a data stream. However, since dubbing operation requires a certain amount of processing time, internal dubbing operation is performed every time loop recording is completed, which poses inconvenience and impairs the user's convenience.

According to one embodiment of the invention, there is provided a recorder suitable particularly for achieving the loop recording of the latter mode.

Embodiments of the present invention are described in detail by reference to the drawings.

### First Embodiment

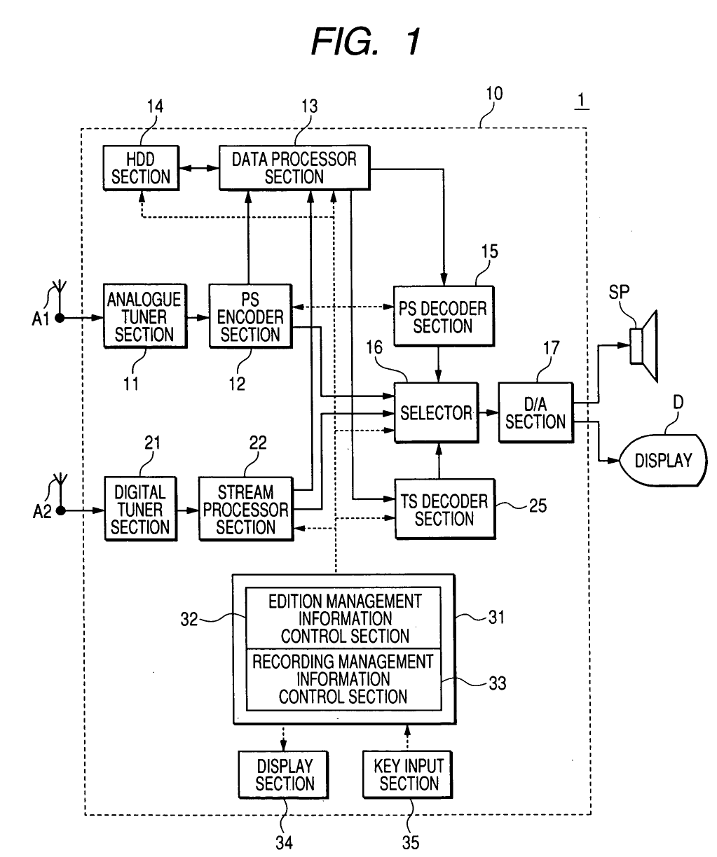

FIG. 1 is an exemplary block diagram showing the configuration of a recorder according to the first embodiment of the present invention.

As shown in FIG. 1, a recorder 10 of the present embodiment constitutes a television system 1 along with a speaker SP, a display D, an analogue antenna A1 for receiving an analogue terrestrial broadcast, and a digital antenna A2 for receiving a digital terrestrial or BS or CS broadcast.

The recorder 10 of the present embodiment includes an analogue tuner 11, a PS encoder section 12, a data processor section 13, an HDD section 14, a PS decoder section 15, a selector 16, a D/A section 17, a digital tuner section 21, a stream processor section 22, a TS decoder section 25, an arithmetic operation section (CPU section) 31 containing an edition management information control section 32 and a recording management information control section 33, a display section 34, and a key input section 35.

The analogue tuner 11 chiefly receives an analogue broadcast waveform broadcast by means of terrestrial waves, through an analogue antenna A1. The analogue tuner section 11 selects and demodulates a broadcast wave according to a predetermined broadcast scheme such as an NTSC scheme to convert the broadcast wave into an analogue video signal and an audio signal, and inputs the converted video signal and the audio signal to the PS encoder section 12.

The PS encoder section 12 operates as an encoding unit including an A/D converter for digitizing an input analogue video signal and an input analogue audio signal, a video encoder, and an audio encoder. The PS encoder section 12 may also include a sub-video encoder. The PS encoder section 12 converts the digitized video signal into a compressed digital video signal of variable bit rate complying with MPEG2 or MPEG1 standards. The PS encoder section 12 converts the digitized video signal into a compressed digital video signal of fixed bit rate complying with the MPEG or AC-3 standards or a digital audio signal of linear PCM. Upon receipt of an analogue video signal and an analogue audio signal as inputs from the analogue tuner section 11, the PS encoder section 12 performs predetermined encoder processing. Specifically, the PS encoder section 12 converts the video signal and the audio signal into digital signals, and encodes and packs the digital signals thereby converting the signals into a video pack, an audio pack, and a sub-video pack. Then, the PS encoder section 12 combines the packs to convert the packs into a format suitable for recording into the HDD section 14. The signal converted by the PS encoder section 12 is passed to the data processor section 13. The PS encoder section 12 may pass the A/D-converted digital video signal and the A/D-converted audio signal directly to the selector 16 without encoding them.

The data processor section 13 operates as a data control unit configured to receive the digital video signal and the digital audio signal, which have been encoded by the PS encoder section 12, and to write the received signals into the HDD section 14 in a subsequent stage. Specifically, the data processor 13 receives data in GOP units from a formatter provided in the PS encoder section 12 when contents of an analogue broadcast are recorded, and data on a per-GOP basis from the stream processor section 22 when contents of a digital broadcast are recorded, and records the received contents into the HDD section 14. In addition, the data processor section 13 has the function of reading a predetermined playback signal from the HDD section 14. The data processor section 13 includes a buffer circuit, a modulation/demodulation circuit, an error correction circuit, and the like, and performs data processing in units suitable for recording or playback.

The HDD section 14 is a recorder which drives a storage medium, e.g., a hard disk drive, to record or play back data. The HDD section 14 is not limited to a hard disk drive, and may be any device capable of recording/playing back digital data.

The PS decoder section 15 operates as a decoding unit including: a separator for separating and extracting packs, such as a video pack or an audio pack, from a multiple signal recorded in the HDD section 14 in a pack structure; memory used for separating packs or at the time of performance of other signal processing; a video decoder for decoding main video data (contents of a video pack) separated by the separator; a sub-picture decoder for decoding sub-video data (contents of a sub-video pack) separated by the separator; and an audio decoder for decoding (contents of an audio pack) audio data separated by the separator. The PS decoding section 15 may also have a video processor for merging a decoded sub-video into the decoded main video, as appropriate, and outputting the main video while superimposing other sub-videos, such as a menu, a highlight button, a caption, and the like, on the main video. The PS decoding section 15 basically decodes the video/audio signal of the analogue broadcast which has been subjected to analog-to-digital conversion and recorded in the HDD section 14.

The selector 16 operates as a signal switching unit configured to select any one from a signal output from the PS decoder section 15, a signal output from the TS decoder section 25, a signal output from the PS encoder section 12, and a signal output from the stream processor section 22, and outputs the selected signal to the D/A section 17. Specifically, the selector 16 selects any one of the analog broadcast signal recorded in the HDD section 14, the digital broadcast signal recorded in the HDD section 14, the analog broadcast signal digitized by the PS encoder section 12, and a digital broadcast signal from the stream processor section 22. The selector 16 performs selecting operation in accordance with a select signal output from the CPU section 31.

The D/A section 17 converts the digital video signal and the audio signal, which have been selected by the selector 16, into an analogue video signal and an analogue audio signal. The D/A section 17 outputs the converted analogue video signal and the converted analogue audio signal to the display D and the speaker SP.

The digital tuner section 21 corresponds to the analogue tuner section 11 and receives a terrestrial digital broadcast or a BS or CS digital broadcast via the digital antenna A2. The digital tuner section 21 extracts a TS (Transport Stream) packet, such as a video packet or an audio packet, of the program selected by the user from the MPEG2-TS signal, and inputs the extracted TS packet to the stream processor section 22.

The stream processor section 22 operates as a data conversion unit configured to perform conversion processing, such as processing of video data and audio data divided into small TS packets extracted by the digital tuner section 21 into packets of larger size suitable for recording in the HDD section 14. The converted information is recorded in the HDD section 14 via the data processor section 13.

The TS decoder section 25 operates as a decoding unit which corresponds to the PS decoder section 15 and decodes the recorded signal of the digital broadcast read from the HDD section 14 via the data processor section 13. The TS decoder section 25 includes: a separator configured to separate to extract a video signal and an audio signal from the recorded multiplex signal; a video decoder configured to decode the separated video data; and an audio decoder configured to decode the separated audio data. The TS decoding section 25 inputs the decoded digital video signal and the decoded digital audio signal into the selector 16.

In accordance with a control program, the CPU section 31 performs processing, such as detection of a defective location, detection of an unrecorded area, setting of a location where recording information is recorded, UDF recording, setting of an AV address, and the like. The CPU section 31 includes an information processing section required to control the entire system containing a work RAM, a video management information preparation section, a copy-related information detection section, a copy-and-scrambling information processing section, a packet header processing section, a sequence header processing section, and an aspect ratio information processing section (which are not illustrated).

The CPU section 31 also includes the edition management information control section 32 configured to control management information required when edition is performed, and the recording management information control section 33 configured to control management information required when recording is performed. Moreover, the CPU section 31 prepares management information required for playing back recorded data, and sends, to the data processor section 13, the management information prepared when recording of data is completed, whereby the management information is recorded in the HDD section 14. Accordingly, the CPU section 31 receives information of data units (separation information or the like) from the PS encoder section 12 when encoding is performed or from the stream processor section 22 when the MPEG2-TS signal is being recorded. At the time of initiation of recording operation, the CPU section 31 has the function of: ascertaining the management information about the file system read from the hard disk drive; ascertaining an unrecorded area in the hard disk drive; and setting a data recording area in the hard disk drive by way of the data processor section 13.

The edition management information control section 32 operates as a management data control unit configured to edit the management information corresponding to the video signal and the audio signal, which are recorded in the HDD section 14.

The recording management information control section 33 operates as a management data control unit configured to set, or the like, the management information by means of controlling recording of the video signal and the audio signal into the HDD section 14.

The display section 34 operates as a display unit configured to display operating status or the like of the CPU section 31 to the user, and includes, e.g., an LCD element. The key input section 35 is an input device for inputting a user's instruction to the CPU section 31 and includes, e.g., a keyboard or a remote controller.

Recording/playback operation of the television system 1 including the recorder 10 of the present embodiment will now be described.

In the case of an analogue broadcast signal, the analogue tuner section 11 receives an analogue broadcast wave from the analogue antenna A1, and subjects the received wave to tuning and demodulation, thereby converting the wave into an analogue video signal and an analogue audio signal and outputting the converted signals to the PS encoder section 12. Upon receipt of the analogue video signal and the analogue audio signal, the PS encoder section 12 subjects the video signal and the audio signal to A/D conversion to pack (format) the signals, and outputs the packed signals to the data processor section 13. At this time, the CPU section 31 prepares management information and passes the prepared management information to the data processor section 13. The data processor section 13 records the received video and audio signals into the HDD section 14 along with the management information.

Meanwhile, the video signal and the audio signal, which are recorded in the HDD section 14, are read by the data processor 13 and passed to the PS decoder section 15. The PS decoder section 15 separates packed signals from the read video signal and the read audio signal, and decodes the packed signals and outputs the decoded signals to the selector 16. The selector 16 passes the received signals to the D/A section 17. The D/A section 17 subjects the received digital video and audio signals to D/A conversion, and outputs the video signal to the display D and the audio signal to the speaker SP.

In the case of a digital broadcast signal, the digital tuner section 21 receives a digital broadcast wave from the digital antenna A2, and subjects the received wave to tuning and demodulation, thereby extracting digital video and audio signals. In the case of a digital broadcast, a video and an audio have been encoded by a broadcast station and assume the format of the MPEG2-TS signal. The stream processor 22 selects required packets from the received MPEG2-TS signal, converts the TS packet into a packet for recording purposes, and passes the converted packet to the data processor section 13. The data processor section 13 records the received data in the HDD section 14.

Meanwhile, the digital broadcast video signal and the digital broadcast audio signal, which are recorded in the HDD section 14, are read by the data processor 13 and passed to the TS decoder section 25. The TS decoder section 25 separates packed signals from the read video signal and the read audio signal, and decodes the packed signals and outputs the decoded signals to the selector 16. The selector 16 passes the received signals to the D/A section 17. The D/A section 17 subjects the received digital video and audio signals to D/A conversion, and outputs the video signal to the display D and the audio signal to the speaker SP.

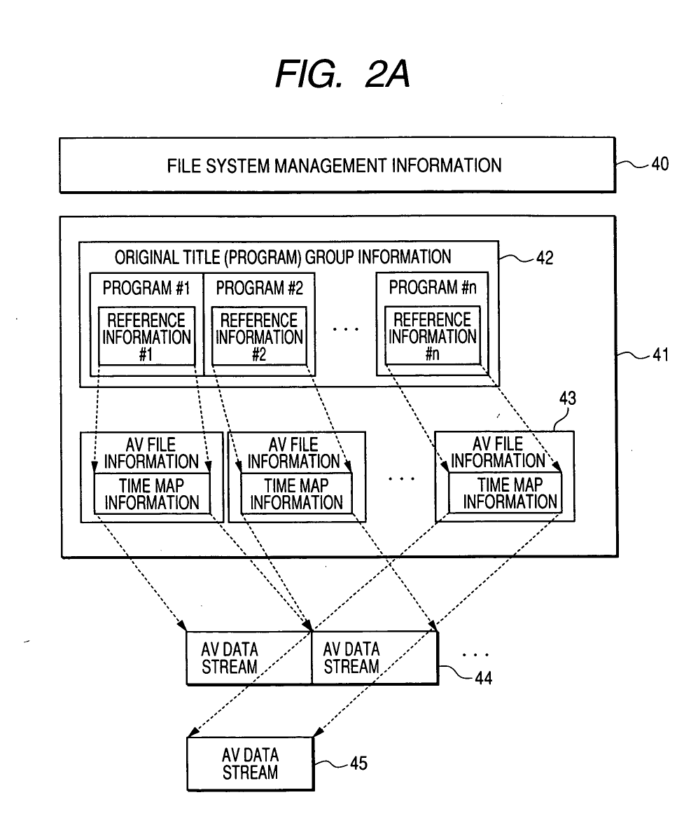

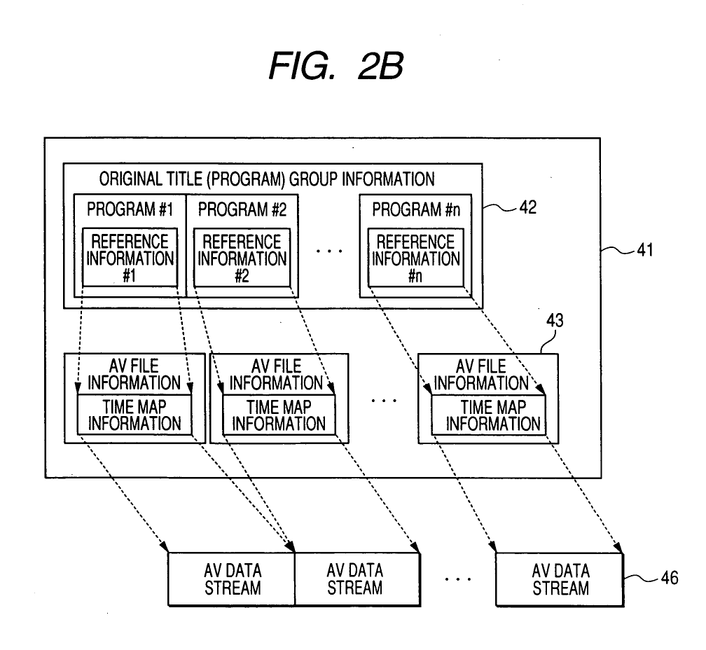

By reference to FIGS. 2A and 2B, the configuration of the data recorded in the HDD section 14 by the recorder 10 of the present embodiment will be described in detail. FIGS. 2A and 2B are exemplary schematic views showing the overview of configuration of the data in the recorder 10 of the first embodiment.

As shown in FIG. 2A, the data recorded in the recorder 10 of the present embodiment are recorded in the HDD section 14, and include file system management information 40, management information 41, a first AV stream file 44, and a second AV stream file 45.

The management information 41 manages position information and attribute information, etc., of the data recorded in the HDD section 14. The management information 41 has program group information 42 and AV file information 43.

The program group information 42 (original title group information) is information (playback sequence information) for managing the playback sequence of recorded contents (programs), and pieces of information pertaining to respective programs are catalogued in programs. Each of the pieces of program information includes reference information linked to AV file information about an AV data stream (an aggregate of video and audio data of each program) which is an object of playback.

The AV file information 43 is a table for linking the program information 42 to be managed by the user, to recorded data that are actually-recorded data. The AV file information 43 includes time map information where logical address information in a corresponding AV data stream in the HDD section 14 is written.

The first and second AV stream files 44 and 45 are data files including AV data streams corresponding to the respective programs (a title: a unit to be recorded once by the user). Each of the AV data streams forming the first and second AV stream files 44 and 45 includes an information pack, a video pack, an audio pack, and a sub-video pack. The information pack corresponds to the information package used as attributes of an AV data stream or used for identifying the AV data stream. The information pack includes information showing a start time when the first field of GOP to which the information pack pertains is played back, information showing the time when the GOP is recorded, copy control information, and the like. The video pack corresponds to an information package into which video data are compressed in the MPEG2 scheme, and includes a pack header, a packet header, and a video data section. The audio pack corresponds to an information package into which audio data are processed according to, e.g., linear PCM, an MPEG, and an AC-3 scheme. The audio pack includes the pack header, the packet header, and the audio data section.

The first AV stream file 44 is a data file prepared for normal recording and playback purposes. The second AV stream file 45 is a data file prepared for loop recording purpose. The term “normal recording” designates recording intended for storage purpose, and the term “loop recording” designates recording which enables storage of a program for a given period of time by means of repeatedly recording, in an overwriting manner, the program in a predetermined area.

The file system management information 40 complies with, e.g., UDF (Universal Disk Format) standards, and manages a file of the management information 41 and first and second AV stream files 44 and 45.

In addition to the program group information 42, play list information formed only from information (playback sequence information) used for managing a playback sequence of a program may also be provided. The play list information does not have an AV data stream of its own, and is generated by means of editing (deleting or adding) the reference information linked to the AV file information about an original title. Specifically, a program formed from only required scenes can be generated by means of editing only the reference information without directly processing the AV data stream, or a program from which unwanted scenes are deleted can be generated.

The example shown in FIG. 2A shows presence of the two first and second AV stream files 44 and 45. However, three or more AV stream files may be present.

Moreover, the stream files can also be reduced to only one. FIG. 2B shows an example where only one AV stream file is present. In the example shown in FIG. 2B, respective AV data streams are recorded in a single AV stream file 46 in a recording medium. A relationship between the original title (program) group information 42 and the AV file information 43 of the management information 41, and a relationship between the AV file information 43 and the AV data stream are the same as those previously described in connection with FIG. 2A.

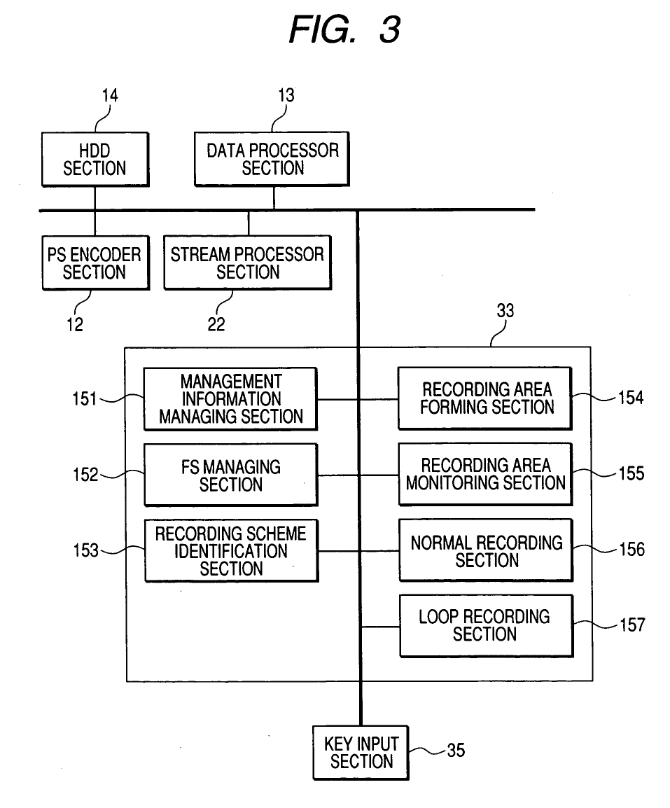

Subsequently, the recording management information control section 33 of the recorder 10 of the present embodiment will be described in detail by reference to FIG. 3. FIG. 3 shows an exemplary block diagram showing the configuration of the recording management information control section 33 shown in FIG. 1. The recording management information control section 33 has the function of performing recording operation of the recorder 10 of the present embodiment.

As shown in FIG. 3, the recording management information control section 33 of the present embodiment includes: a management information managing section 151; an FS managing section 152; a recording scheme identification section 153; a recording area forming section 154; a recording area monitoring section 155; a normal recording section 156; and a loop recording section 157. The recorder 10 of the present embodiment performs recording operation by means of the data recording configuration shown in FIG. 2A, namely, a configuration of separating an AV stream file for normal recording from an AV stream file for loop recording.

The management information managing section 151 operates as an information processing unit configured to manage the program group information 42 shown in FIG. 2A and the AV file information file 43. The management information managing section 151 has the function of providing the user with the program group information recorded in the HDD section 14 through the display section 34 and the display D and setting program group information at the time of recording. The program group information 42 managed by the management information managing section 151 includes time information (time information showing a position in the data recorded in the HDD section 14) for each program. The AV file information 43 managed by the management information managing section 151 includes logical address information corresponding to information about the logical position of the recorded data.

The FS managing section 152 operates as an information processing unit configured to manage the file system management information 40 complying with; e.g., UDF (Universal Disk Format) standards. In the recorder 10 of the present embodiment, recorded data pertaining to each program are strung out to thus form an AV stream file. The FS management information is information used for identifying an AV stream file. The FS managing section 152 manages an AV stream file by means of FS management information.

The recording scheme identification section 153 operates as a recording scheme management unit configured to identify a recording scheme included in the user's instruction input from the key input section 35. The recording scheme managed by the recording scheme identification section 53 includes normal recording for effecting normal recording and loop recording for effecting recording by repeatedly overwriting a predetermined area. The instruction from the user may be explicit, or may not be explicit to assume unchanged unless an instruction for a cancel is issued.

The recording area forming section 154 operates as a management unit configured to ensure and manage the recording area of the HDD section 14. The recording area forming section 154 has the function of ensuring in advance or opening recording areas for the first and second AV stream files 44 and 45 in the HDD section 14.

The recording area monitoring section 155 operates as a monitoring unit configured to monitor the recording area ensured by the recording area forming section 154. The recording area monitoring section 155 has the function of monitoring the recording area ensured by the recording area forming section 154 and reporting a result of monitoring to the normal recording section 156 or the loop recording section 157.

The normal recording section 156 operates as a processing unit configured to perform normal recording operation, and has the function of instructing the data processor section 13 to normally record the video data and the audio data sent from the PS encoder section 12 or the stream processor section 22 into the HDD section 14.

The loop recording section 157 operates as a processing unit configured to perform loop recording operation. The loop recording section 157 has the function of instructing the data processor section 13 to loop-record the video data and the audio data transmitted from the PS encoder section 12 or the stream processor section 22 into the HDD section 14.

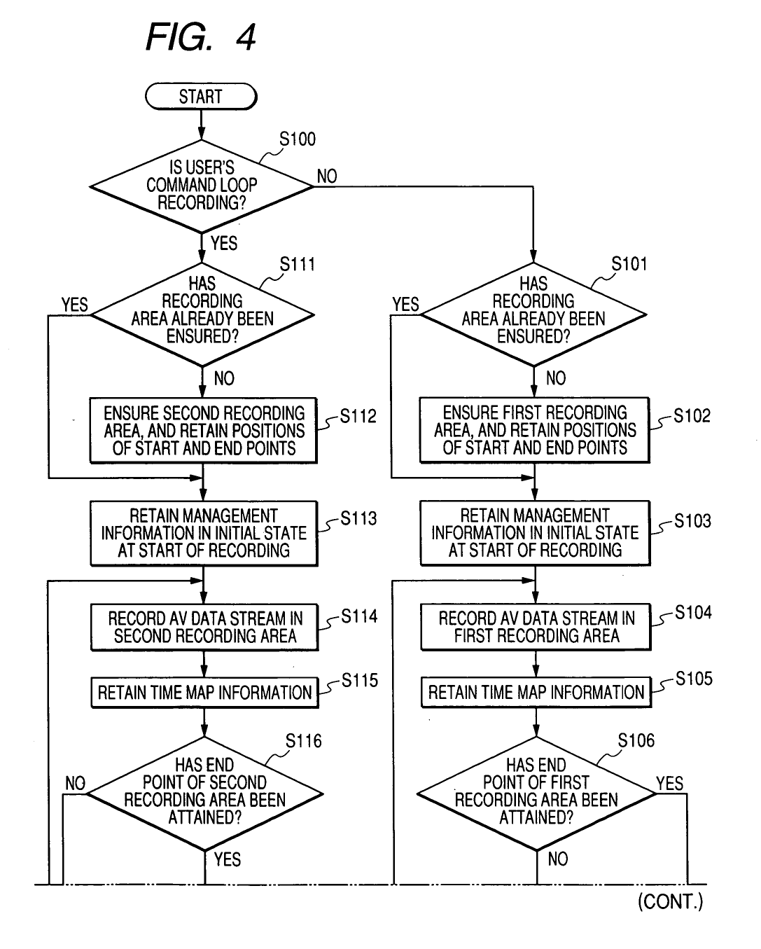

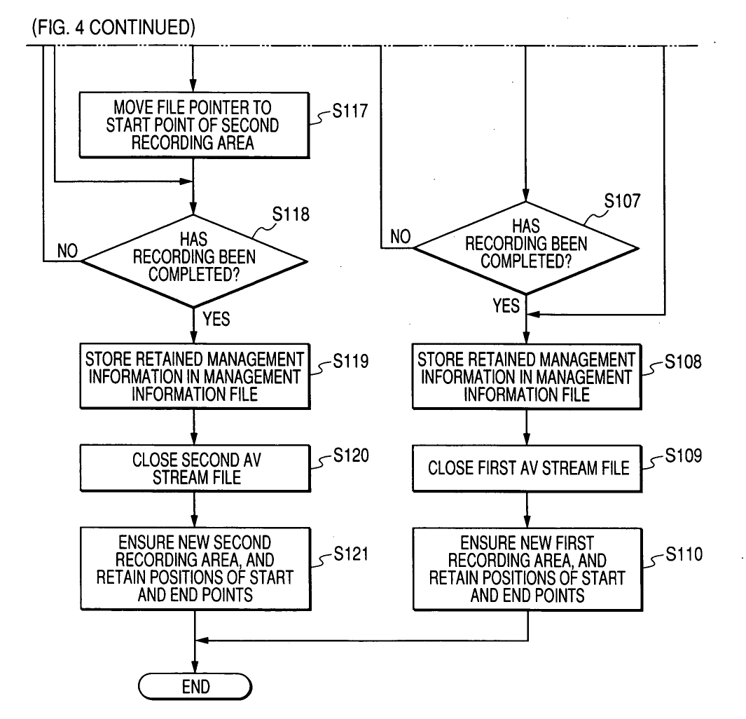

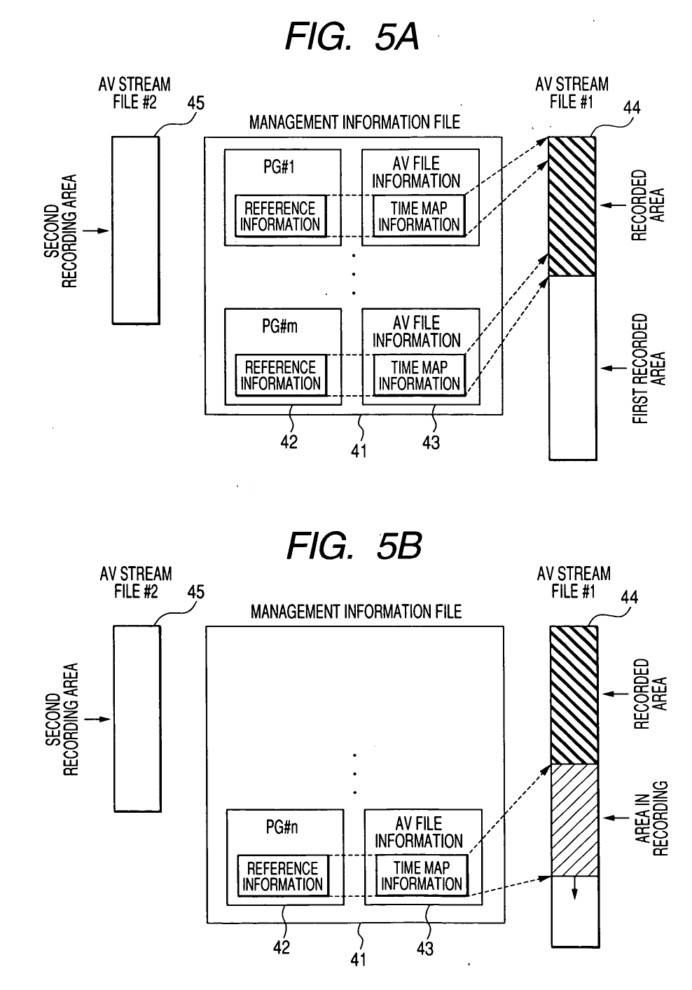

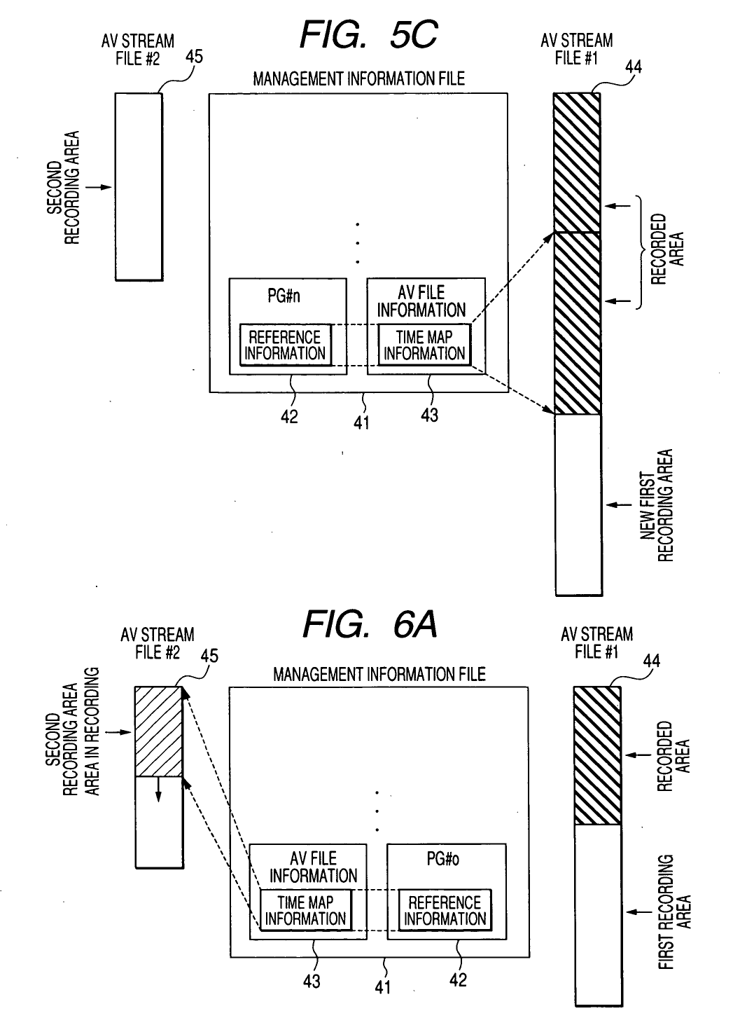

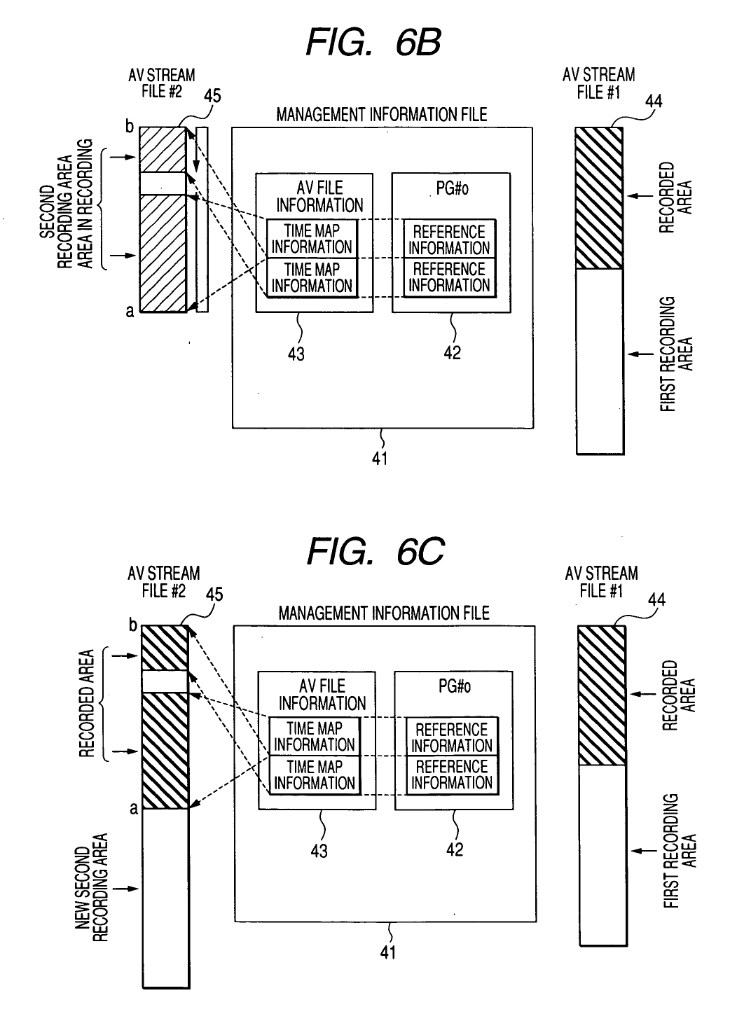

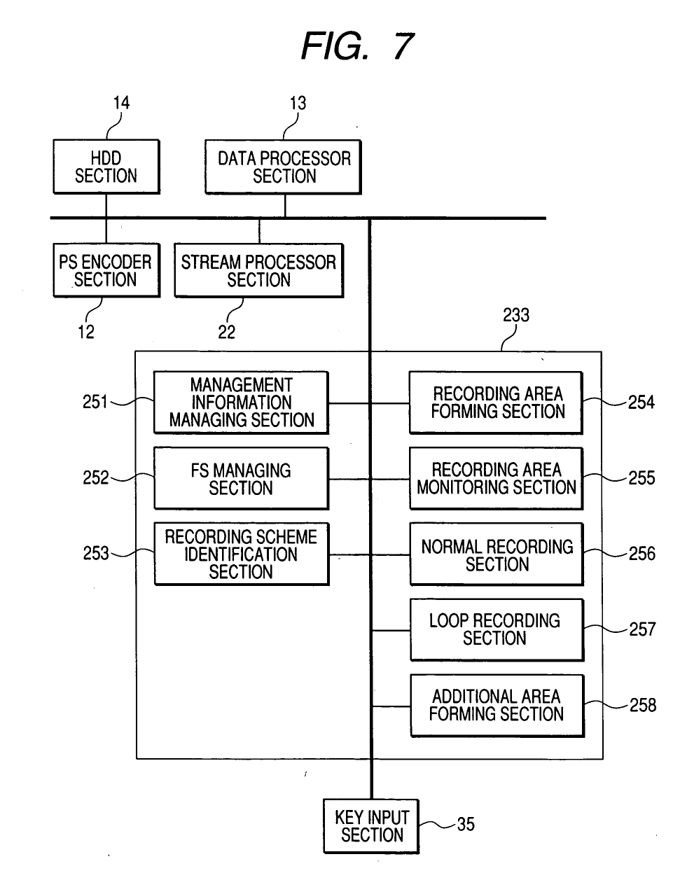

By reference to FIGS. 4, 5A to 5C, and 6A to 6C, operation of the recorder 10 of the present embodiment will now be described. FIG. 4 is an exemplary flowchart showing operation of the recorder 10 of the first embodiment; FIGS. 5A to 5C are exemplary schematic diagrams showing recording operation performed during normal recording of the first embodiment; and FIGS. 6A to 6C are exemplary schematic diagrams showing recording operation performed during loop recording of the first embodiment.

First, FIG. 5A shows the management information 41, the first AV stream file 44, and the second AV stream file 45, all of which are in an initial state. A first recording area for normal recording is ensured in the first AV stream file 44 used during normal recording. Meanwhile, a second recording area for loop recording is ensured in the second AV stream file 45 used in loop recording. In the embodiment shown in FIG. 5A, titles from PG#1 to PG#m have already been recorded as the program group information 42 recorded through normal recording. Although the recorded area has already been formed in the first AV stream file 45 (an area diagonally shaded by thick lines in FIG. 5A), there may be a case where these notations are omitted in the remainder for the sake of description.

When the key input section 35 has received an instruction from the user, the recording scheme identification section 153 determines whether or not the user's instruction signifies loop recording (block S100 in Fig.). When the user's instruction is normal recording (NO in block S100), the recording scheme identification section 153 instructs the normal recording section 156 to perform ordinary recording processing. Upon receipt of the normal recording instruction, the normal recording section 156 queries the recording area monitoring section 155 as to whether or not the recording area for normal recording has been ensured (block S101). Upon receipt of the query, the recording area monitoring section 155 queries the FS managing section 152 as to whether a recording area for normal recording is ensured in either the first AV stream file 44 or the second AV stream file 45. In the present embodiment, normal recording is assigned to the first AV stream file 44, and hence in reply the FS managing section 152 specifies, as the file system for normal recording purpose, the file system where the first AV stream file 44 is present. The recording area monitoring section 155 determines whether or not the recording area for normal recording (hereinafter called a “first recording area”) is ensured in the first AV stream file 44 in the file system specified by the FS managing section 152, and passes a result of determination to the normal recording section 156.

When the result of determination shows that the first recording area has not been ensured (NO in block S101), the normal recording section 156 instructs the recording area forming section 154 to ensure the first recording area. The recording area forming section 154 forms the first recording area in the first AV stream file 44 of the HDD section 14, and returns the logical address of the start point of the first recording area and the logical address of the end point of the same to the normal recording section 156 (block S102). FIG. 5A shows this state.

When the result of determination shows that the first recording area has been ensured (YES in block S101) or that the recording area forming section 154 has ensured the first recording area, the normal recording section 156 generates management information of initial state at the start of recording, and retains the management information in internal memory (block S103). More specifically, the normal recording section 156 instructs the management information managing section 151 to generate the management information 41 pertaining to the entire contents to be recorded, from among the program group information 42, the reference information, and the AV file information 43. Upon receipt of the instruction, the management information managing section 151 receives the logical address of the start point of the first recording area specified by the recording area forming section 154 and the logical address of the end point of the same from the normal recording section 156. The management information managing section 151 sets the logical addresses as time map information in the AV file information 43.

When the management information 41 is generated, the normal recording section 156 records the video data and the audio data, which are sent from the PS encoder section 12 or the stream processor section 22, in the first recording area ensured in the first AV data stream file 44 of the HDD section 14 (block S104). During the course of recording of the data into the first recording area, the management information managing section 151 generates, from moment to moment, time map information reflecting a progress in recording of the AV data stream, and records the generated time map information into the AV file information 43 of the memory (block S105). FIG. 5B shows that contents are recorded in the first recording area of the first AV stream file 44 through normal recording. In FIG. 5B, the contents are recorded through normal recording under a new title PG#n. As shown in FIG. 5B, the AV data stream (as diagonally hatched by fine lines), which is to be recorded through normal recording, is recorded in the first recording area. The time map information, which is management information, corresponds to the AV data stream recorded in the first recording area.

During recording operation of the normal recording section 156, the recording area monitoring section 155 monitors the state of the first recording area that is being recorded by the normal recording section 156, and reports the state to the normal recording section 156 (block S106). Specifically, the recording area monitoring section 155 determines a location to which the AV data stream has been recorded in the recording medium (in the first AV stream file 44), based on the time map information generated by the management information managing section 151. Then the recording area monitoring section 155 compares the determined position with the retained position of the end point of the first recording area (the logical address on the recording medium), thereby determining whether or not the end point of the first recording area has been achieved.

When the recording point of the normal recording section 156 is not the end point of the first recording area (NO in block S106), the normal recording section 156 determines whether or not recording has been completed. When recording has not been completed (NO in block S107), recording operation is continued (block S104).

When the recording point of the normal recording section 156 is the end point of the first recording area (YES in block S106) or when the normal recording section 156 has determined completion of recording (YES in block S107), the normal recording section 156 instructs the management information managing section 151 to complete recording. Upon receipt of the instruction, the management information managing section 151 records the management information 41 recorded thus far as a management information file in the HDD section 14 (block S108), and the normal recording section 156 completes recording operation. The management information managing section 151 closes the first AV stream file 44 (block S109).

Subsequently, the recording area forming section 154 forms a new first recording area, and passes the logical address of a starting point of the first recording area and the logical address of an end point of the same to the management information managing section 151, thereby obviating the necessity of ensuring the recording area in block S102 in the next normal recording session. FIG. 5C shows that normal recording of contents into the first AV stream file 44 has ended. Here, since recording of the title PG #n has completed (as diagonally hatched by thick lines), a new first recording area is ensured in the first AV stream file 44 for the next normal recording operation.

When the user's instruction received from the key input section 35 is loop recording (YES in block S100), the recording scheme identification section 153 instructs the loop recording section 157 to perform loop recording. Upon receipt of the instruction for loop recording, the loop recording section 157 makes a query to the recording area monitoring section 155 as to whether or not the recording area for loop recording has been ensured (block S111). Upon receipt of the query, the recording area monitoring section 155 queries the FS managing section 152 as to whether a recording area for loop recording is ensured in either the first AV stream file 44 or the second AV stream file 45. In the present embodiment, loop recording is assigned to the second AV stream file 45, and hence in reply the FS managing section 152 provides, as the file system for loop recording purpose, the file system where the second AV stream file 45 is present. The recording area monitoring section 155 determines whether or not the recording area for loop recording (hereinafter called a “second recording area”) is ensured in the second AV stream file 45 in the file system provided by the FS managing section 152, and passes a result of determination to the loop recording section 157.

When the result of determination shows that the second recording area has not been ensured (NO in block S111), the loop recording section 157 instructs the recording area forming section 154 to ensure the second recording area. The recording area forming section 154 forms the second recording area in the second AV stream file 45 of the HDD section 14, and returns the logical address of the start point of the second recording area and the logical address of the end point of the same to the loop recording section 157 (block S112).

When the result of determination shows that the second recording area has been ensured (YES in block S111) or that the recording area forming section 154 has ensured the second recording area, the loop recording section 157 generates management information 41 of initial state achieved at the start of recording, and retains the management information in internal memory (block S113). More specifically, the loop recording section 157 instructs the management information managing section 151 to generate the management information 41 pertaining to the entire contents to be recorded from among the program group information 42, the reference information, and the AV file information 43. Upon receipt of the instruction, the management information managing section 151 receives, from the loop recording section 157, the logical address of the start point of the second recording area provided by the recording area forming section 154 and the logical address of the end point of the same, and sets the logical addresses as time map information in the AV file information 43.

When the management information 41 is generated, the loop recording section 157 records the video data and the audio data, which are sent from the PS encoder section 12 or the stream processor section 22, in the second recording area ensured in the second AV data stream file 45 of the HDD section 14 (block S114). During the course of recording of the data into the second recording area, the management information managing section 151 generates, from moment to moment, time map information reflecting a progress in recording of the AV data stream, and records the generated time map information into the AV file information 43 of the memory (block S115). FIG. 6A shows that contents are recorded in the second recording area of the second AV stream file 45 through loop recording. In FIG. 6A, contents are recorded through loop recording under a new title PG#o. As shown in FIG. 6A, the AV data stream (as diagonally hatched by fine lines), which is to be recorded through loop recording, is recorded in the second recording area. The time map information, which is management information, corresponds to the AV data stream recorded in the second recording area.

During recording operation of the loop recording section 157, the recording area monitoring section 155 monitors the state of the second recording area that is being recorded by the loop recording section 157, and reports the state to the loop recording section 157 (block S116). Specifically, the recording area monitoring section 155 determines a location up to which the AV data stream has been recorded in the recording medium (in the second AV stream file 45), based on the time map information generated by the management information managing section 151. Then, the recording area monitoring section 155 compares the determined position with the retained position of the end point of the second recording area (the logical address), thereby determining whether or not the end point of the second recording area has been achieved.

When the recording point of the loop recording section 157 is not the end point of the second recording area (NO in block S116), the loop recording section 157 determines whether or not recording has been completed. When recording has not been completed (NO in block S118), recording operation is continued (block S114). When the loop recording section 157 does not determine that recording has been completed, loop recording operation is continued, and repeated overwriting is performed in the second recording area.

When the recording point of the loop recording section 157 is the end point of the second recording area (YES in block S116), the loop recording section 157 moves a file pointer (a recording point) of the second AV stream file 45 to the position of the start point retained in the second recording area (a logical address on a recording medium) (block S117). Thereby, recording of a subsequent AV data stream is performed as overwrite-recording from the start point of the second recording area, whereby there is performed overwrite-recording by means of which the inside of ensured second recording area is reused frequently, i.e., loop recording.

When a loopback has arisen in the second recording area, the position of the start point in time map information, where recording of contents in the second AV data stream file 45 has started, must be adjusted. The management information managing section 151 shifts the position of the start point of a subsequent AV data stream backward in terms of time, by means of overwrite-recording.

FIG. 6B shows that a loopback has arisen in the second recording area during the course of loop recording of contents into the second AV stream file 45. Among the AV data streams recorded through loop recording, an AV data stream “a” in the drawing is old. Since the end of the AV data stream “a” has reached the end point of the second recording area, the file pointer of the second AV stream file 45 is reset to the start point of the second recording area, whereby a subsequent portion is recorded as an AV data stream “b.” At that time, the AV data stream “b” is sequentially recorded in an overwriting manner from a position preceding the head of the AV data stream “a.” Accordingly, in association with overwrite-recording of the AV data stream “b,” the time map information indicating the AV data stream “a” shifts the position of the start point of the indicated AV data stream “a.”

In FIG. 6B, a point of connection between the AV data stream “a” and the AV data stream “b” is made discontiguous as a result of occurrence of a loopback. Therefore, pieces of time map information indicating respective AV data streams are provided separately. However, the present embodiment is not limited to such time map information. For instance, there may also be adopted a mechanism for pointing out the entire second recording area by means of one piece of time map information, and retaining information about the start point/end point of the recorded AV data stream separately and uniquely. In FIG. 6B, slight clearance exists between the last of the AV data stream “b” and the head of the AV data stream “a,” but the clearance is not always indispensable.

When the loop recording section 157 has determined end of recording (YES in block S118), i.e., when the user instructs recording of the data having been recorded through loop recording for storage purpose, the loop recording section 157 instructs the management information managing section 151 to complete recording. Upon receipt of the instruction, the management information managing section 151 records the management information 41 having been recorded thus far, in the HDD section 14 as a management information file (block S119). The loop recording section 157 completes recording operation, and the management information managing section 151 closes the second AV stream file 45 (block S120). As a result of the management information managing section 151 having recorded the management information file, the recorded area of the second AV stream file 45 where recording has been completed is set in the program group information 42 as a recorded area (as obliquely hatched by thick lines in FIG. 6C). The recorded area is brought under common management along with the area of the first AV stream file 44 that has been recorded through normal recording.

Subsequently, the recording area forming section 154 newly forms a second recording area, and passes the logical address of the start point of the second recording area and the logical address of the end point of the same to the management information managing section 151, thereby obviating the necessity of ensuring the recording area in block S112 in the next loop recording session. FIG. 6C shows that loop recording of contents into the second AV stream file 45 has ended. Here, since recording of the title PG #o has been completed, a new second recording area is ensured in the second AV stream file 45 for the next loop recording session. FIG. 6C adopts a mechanism for indicating the recorded AV data stream “a” and the AV data stream “b” by means of separate pieces of time map information. However, as described in connection with FIG. 6B, there may also be adopted a mechanism for pointing out the entire second recording area by means of one piece of time map information, and retaining information about the start point/end point of the recorded AV data stream separately and uniquely. In addition, a slight clearance exists between the last of the recorded AV data stream “b” and the head of the AV data stream “a,” but the clearance is not always required.

As mentioned above, according to the recorder 10 of the first embodiment, the management information managing section 151 manages the management information about normal recording and the management information about loop recording by means of the common program group information 42 and the AV file information 43. Hence, the management information can be provided to the user as program information without making a distinction between normal recording and loop recording.

Further, according to the recorder 10 of the present embodiment, when the loop recording section 157 instructs completion of recording, loop-recorded data are stored as a recorded area used for storage data. Hence, even in the case of loop-recorded data, the data can be recorded as storage data which are not subjected to overwriting.

Further, according to the recorder 10 of the present embodiment, the recording area forming section 154 ensures a new second recording area for the next loop recording session after completion of loop recording. Hence, loop-recorded data are not subjected to overwriting and can be permanently stored as in the case of normal recording.

### Second Embodiment

By reference to FIG. 7, a recorder according to a second embodiment of the present invention will be described in detail. FIG. 7 is an exemplary block diagram showing a configuration of a recording management information control section 233 of the recorder of the second embodiment of the present invention. The recorder of the present embodiment is identical with the recorder 10 of the first embodiment, except that the recording management information control section 33 is replaced. Elements of the recorder common to those of the recorder 10 of the first embodiment shown in FIGS. 1 through 3 are assigned corresponding reference numerals, and repeated explanations thereof are omitted.

As shown in FIG. 7, the recording management information control section 233 of the present embodiment includes: a management information managing section 251; an FS managing section 252; a recording scheme identification section 253; a recording area forming section 254; a recording area monitoring section 255; a normal recording section 256; a loop recording section 257; and an additional area forming section 258. As in the case of the first embodiment, the recorder of the present embodiment performs recording operation by means of the data recording configuration shown in FIG. 2A, i.e., a configuration of separating an AV stream file for normal recording from an AV stream file for loop recording.

The management information managing section 251, the FS managing section 252, the recording scheme identification section 253, and the normal recording section 256 have the same functions as those of the management information managing section 151, the FS managing section 152, the recording scheme identification section 153, and the normal recording section 156, all of which pertain to the first embodiment. The recording area forming section 254, the recording area monitoring section 255, and the loop recording section 257 have the same functions as those of the recording area forming section 154, the recording area monitoring section 155, and the loop recording section 157, all of which pertain to the first embodiment. They differ from each other in that two recording areas are managed in connection with loop recording.

The additional area forming section 258 operates as a management unit configured to ensure a recording area used for avoiding overwriting by compensating for a deficiency in the second recording area for loop recording, when overwriting of data to the data recorded in the second AV stream file 45 for loop recording is not desired, i.e., when it is desired that the data having recorded for loop recording is recorded as normal recording without interruption. Specifically, when data to be loop-recorded fit in the previously-ensured second recording area or when the result of data loop-recorded in the past is simply stored through normal recording, it is sufficient to take the recorded area of the second recording area as a recorded area, as shown in FIG. 6C. In a case where the user has issued an instruction for changing loop recording to normal recording during the course of loop recording operation, there arises a conceivable case where recorded data to be stored do not fit into the second recording area. The additional area forming section 258 has the function of ensuring in advance a recording area (a third recording area) subsequent to the second recording area on the premise that data do not fit into the second recording area.

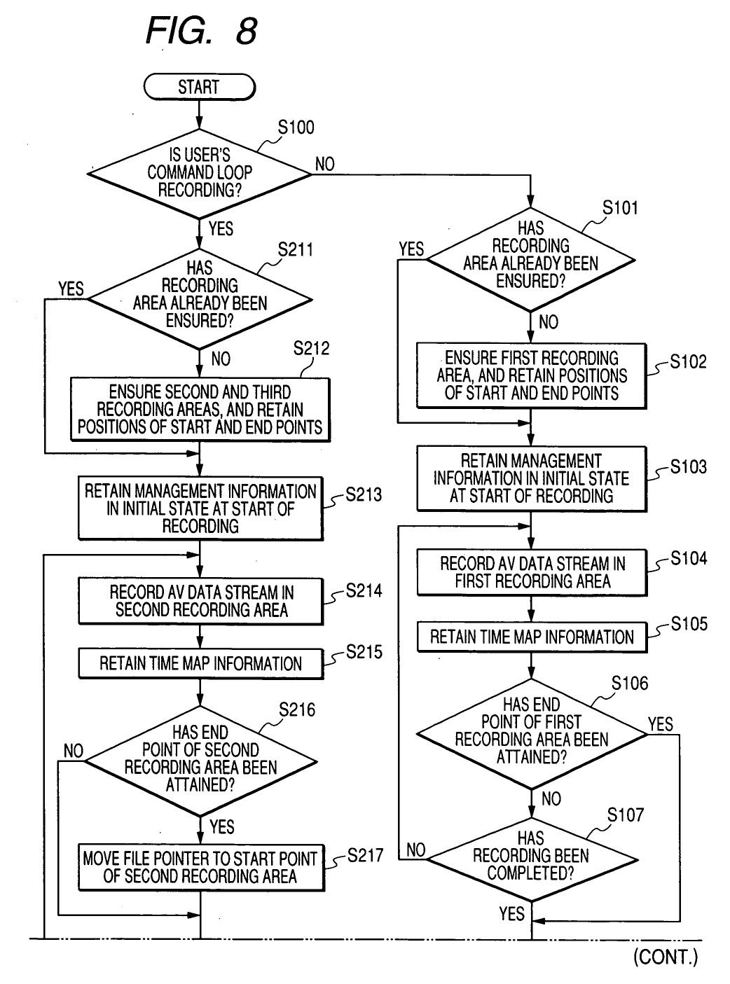

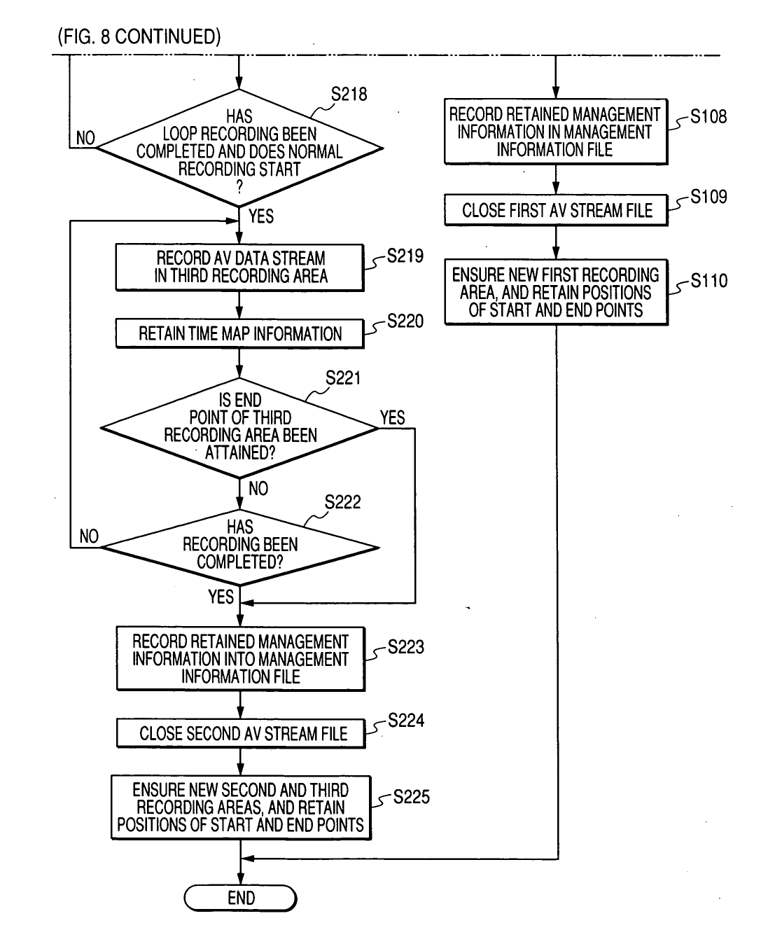

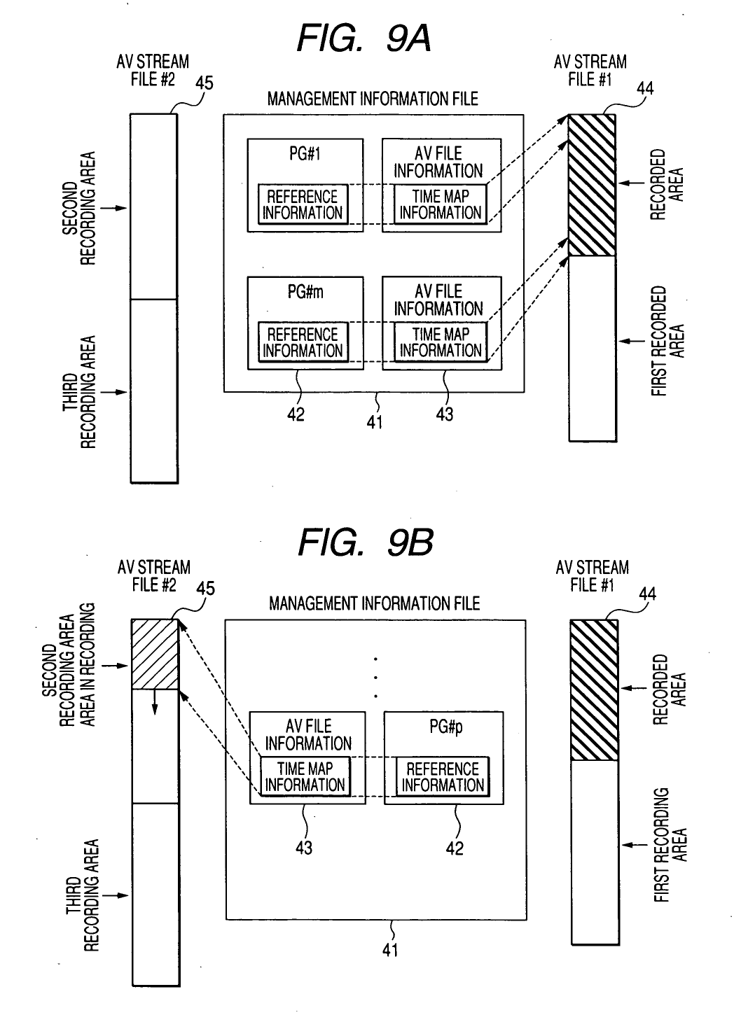

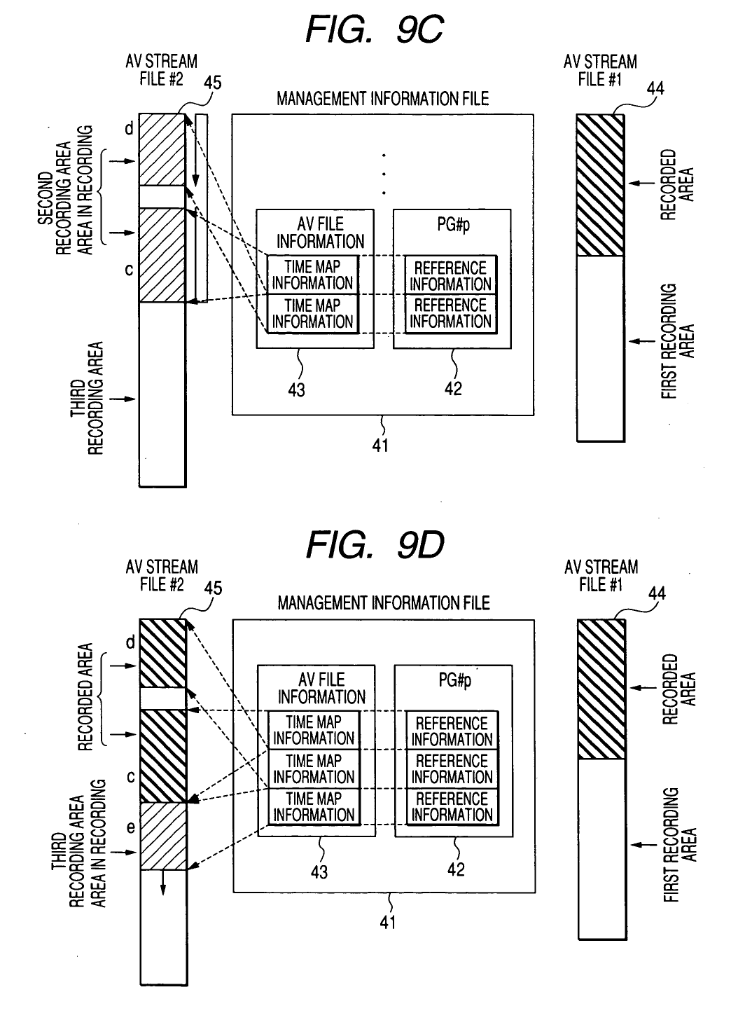

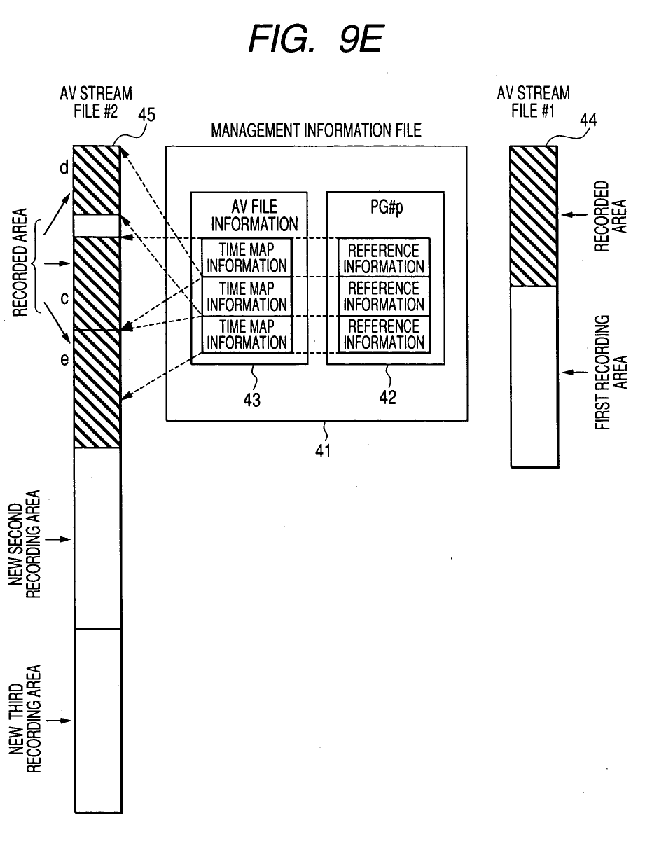

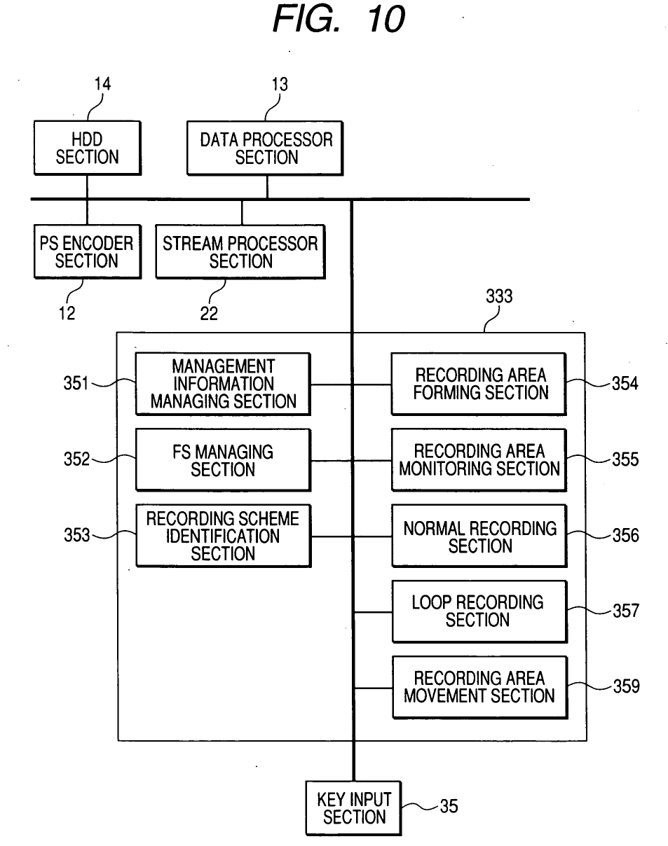

By reference to FIGS. 8 and 9A to 9E, operation of the recorder of the present embodiment will now be described. FIG. 8 is an exemplary flowchart showing operation of the recorder of the present embodiment, and FIGS. 9A to 9E are exemplary schematic diagrams showing recording operation performed during loop recording of the present embodiment. The recorder of the present embodiment is identical with that of the first embodiment in terms of normal recording operation. Consequently, descriptions of normal recording will be omitted.

First, FIG. 9A shows the management information 41, the first AV stream file 44, and the second AV stream file 45, all of which are in an initial state. A first recording area for normal recording is ensured in the first AV stream file 44. Meanwhile, a second recording area for loop recording and a third recording area for normal recording to be performed subsequently to completion of loop recording are ensured in the second AV stream file 45. In the embodiment shown in FIG. 9A, titles from PG#1 to PG#m have already been recorded as the program group information 42 recorded through normal recording, and the recorded area is formed in the first AV stream file 44 (an area diagonally shaded by thick lines in FIG. 9A).

When the key input section 35 has received an instruction from the user, the recording scheme identification section 253 determines whether or not the user's instruction signifies loop recording (block S100 in FIG. 8). When the user's instruction is normal recording (NO in block S100), subsequent operations (block S101 to block S110) are the same as those of the first embodiment, and hence their explanations are omitted.

When the user's instruction received from the key input section 35 signifies loop recording (YES in block S100), the recording scheme identification section 253 instructs the loop recording section 257 to perform loop recording. Upon receipt of the instruction for loop recording, the loop recording section 257 makes a query to the recording area monitoring section 255 as to whether or not the recording area for loop recording has been ensured (block S211). Upon receipt of the query, the recording area monitoring section 255 queries the FS managing section 252 as to whether a recording area for loop recording is ensured in the first AV stream file 44 or in the second AV stream file 45. In the present embodiment, loop recording is assigned to the second AV stream file 45, and hence in reply the FS managing section 252 provides, as the file system for loop recording purpose, the file system where the second AV stream file 45 is present. The recording area monitoring section 255 determines whether or not the second recording area and the third recording area are ensured, as the recording area for loop recording, in the second AV stream file 45 of the file system provided by the FS managing section 252, and passes a result of determination to the loop recording section 257.

When the result of determination shows that the second and third recording areas have not been ensured (NO in block S211), the loop recording section 257 instructs the recording area forming section 254 and the additional area forming section 258 to ensure the second and third recording areas. The recording area forming section 254 forms the second recording area in the second AV stream file 45 of the HDD section 14, and returns to the loop recording section 257 the logical address of the start point of the second recording area and the logical address of the end point of the same. Likewise, the additional area forming section 258 forms the third recording area at a position following the second recording area of the second AV stream file 45, and returns to the loop recording section 257 the logical address of the start point of the third recording area and the logical address of the end point of the same (block S212).

When the result of determination shows that the second recording area has been ensured (YES in block S211) or that the recording area forming section 254 and the additional area forming section 258 have ensured the second and third recording areas, the loop recording section 257 generates management information 41 of initial state at the start of recording, and retains the management information in internal memory (block S213). More specifically, the loop recording section 257 instructs the management information managing section 251 to generate information pertaining to the entire contents to be recorded from among the program group information 42, the reference information, and the AV file information 43. Upon receipt of the instruction, the management information managing section 251 receives the logical address of the start point of the second recording area provided by the recording area forming section 254, the logical address of the end point of the same, the logical address of the start point of the third recording area provided by the additional area forming section 258, and the logical address of the end point of the same from the loop recording section 257. Then, the management information managing section 251 sets the logical addresses as time map information in the AV file information 43.

When the management information 41 is generated, the loop recording section 257 records the video data and the audio data, which are sent from the PS encoder section 12 or the stream processor section 22, in the second recording area ensured in the second AV data stream file 45 of the HDD section 14 (block S214). During the course of recording of the data into the second recording area, the management information managing section 251 generates, from moment to moment, time map information reflecting progress in recording of the AV data stream, and records the generated time map information into the AV file information 43 of the memory (block S215). FIG. 9B shows that contents are recorded in the second recording area of the second AV stream file 45 through loop recording. In FIG. 9B, contents are recorded through loop recording under a new title PG#p. As shown in FIG. 9B, the AV data stream (as diagonally hatched by fine lines), which is to be recorded through loop recording, is recorded in the second recording area. The time map information, which is management information, corresponds to the AV data stream recorded in the second recording area.

During recording operation of the loop recording section 257, the recording area monitoring section 255 monitors the state of the second recording area being recorded by the loop recording section 257 (block S216). Specifically, the recording area monitoring section 255 determines a location up to which the AV data stream has been recorded in the recording medium (in the second AV stream file 45), based on the time map information generated by the management information managing section 251. Then, the recording area monitoring section 155 compares the determined position with the retained position of the end point of the second recording area (the logical address on the recording medium), thereby determining whether or not the end point of the second recording area has been achieved.

When the recording point of the loop recording section 257 is not the end point of the second recording area (NO in block S216), the loop recording section 257 determines whether or not recording has been completed. When recording has not been completed (NO in block S218), recording operation is continued (block S214).

When the recording point of the loop recording section 257 is the end point of the second recording area (YES in block S216), the loop recording section 257 moves a file pointer (a recording point) of the second AV stream file 45 to the position of the retained start point in the second recording area (a logical address on a recording medium) (block S217). Thereby, recording of a subsequent AV data stream is performed as overwrite-recording from the start point of the second recording area, whereby there is performed overwrite-recording by means of which the inside of ensured second recording area is reused, i.e., loop recording. When a loopback has arisen in the second recording area, the position of the start point in time map information, where recording of contents in the second AV data stream file 45 has started, must be adjusted. The management information managing section 251 shifts the position of the recording start point of a subsequent AV data stream backward in terms of time, by means of overwrite-recording.

FIG. 9C shows that a loopback has arisen in the second recording area during the course of loop recording of contents into the second AV stream file 45. Among the AV data streams recorded through loop recording, an AV data stream “c” is old. Since the end of the AV data stream “c” has reached the end point of the second recording area, the file pointer of the second AV stream file 45 is reset to the start point of the second recording area, whereby a subsequent portion is recorded as an AV data stream “d.” At that time, the AV data stream “d” is sequentially recorded in an overwriting manner from a position preceding the head of the AV data stream “c.” Accordingly, in association with overwrite-recording of the AV data stream “d,” the time map information indicating the AV data stream “c” shifts the position of the start point of the indicated AV data stream “c.”

In FIG. 9C, a point of connection between the AV data stream “c” and the AV data stream “d” is made discontiguous as a result of occurrence of a loopback. Therefore, pieces of time map information indicating respective AV data streams are provided separately. However, the present embodiment is not limited to such time map information. For instance, there may also be adopted a mechanism for pointing out the entire second recording area by means of one piece of time map information, and retaining information about the start point/end point of the recorded AV data stream separately and uniquely. In FIG. 9C, a slight clearance exists between the last of the AV data stream “d” and the head of the AV data stream “c,” but the clearance is not always required.

When the loop recording section 257 has determined end of recording and the start of normal recording (YES in block S218), the loop recording section 257 provides the management information managing section 251 with an instruction about the end of loop recording and the start of normal recording. Upon receipt of the instruction, the management information managing section 251 records the management information 41, which has been recorded thus far, in the HDD section 14 as a management information file. The loop recording section 257 shifts a file pointer to the start point of the third recording area, thereby continuously performing recording operation as normal recording (block S219). The management information managing section 251 receives from the loop recording section 257 the logical address of the start point of the third recording area and the logical address of the end point of the same, and sets in the AV file information 43 new time map information corresponding to recording of data into the third recording area (block S220). The data recorded in the third recording area are recorded through normal recording and are not overwritten.

FIG. 9D shows that loop recording of data into the second AV stream file 45 has ended and data are successively being recorded in the second AV stream file 45 through normal recording (continued normal recording). In FIG. 9D, an AV data stream, which is to be recorded in the third recording area through continued normal recording, is recorded. The time map information, which corresponds to the management information, indicates an AV data stream “e” recorded in the third recording area. The time map information indicating the AV data stream “e” recorded in the third recording area is included in a title PG#p which is identical with that of the time map information indicating the AV data streams “c” and “d” recorded in the second recording area through loop recording. Namely, the scene recorded through loop recording and a subsequent scene recorded through continued normal recording are grouped into one title.

During recording operation of the loop recording section 257, the recording area monitoring section 255 monitors the state of the third recording area that is being successively recorded by the loop recording section 257, and reports the state of the third recording area to the loop recording section 257 (block S221). Specifically, the recording area monitoring section 255 determines a location up to which the AV data stream has been recorded in the recording medium (in the second AV stream file 45), based on the time map information generated by the management information managing section 251. Then, the recording area monitoring section 255 compares the determined location with the retained position of the end point of the third recording area (the logical address on the recording medium), thereby determining whether or not the end point of the third recording area has been achieved.

When the recording point of the loop recording section 257 is not the end point of the third recording area (NO in block S221), the loop recording section 257 determines whether or not recording has been completed. When recording has not been completed (NO in block S222), recording operation is continued (block S219).

When the recording point of the loop recording section 257 is the end point of the third recording area (YES in block S221) or when the loop recording section 257 determined that recording has ended, the loop recording section 257 provides the management information managing section 251 with an instruction concerning the completion of recording. Upon receipt of the instruction, the management information managing section 251 records the management information 41, which has been recorded thus far, in the HDD section 14 as a management information file (block S223). The loop recording section 257 completes recording operation, and the management information managing section 251 closes the second AV stream file 45 (block S224). As a result of the management information managing section 251 having recorded the management information file, the recorded area in the second AV stream file 45 is set as a recorded area in the program group information 42 (as diagonally hatched by thick lines in FIG. 9E), and the recorded area is brought under common management along with the recorded area of the first AV stream file 44 that has been recorded through normal recording.

Subsequently, the recording area forming section 254 newly forms second and third recording areas, and passes the logical address of the start point of the second recording area, the logical address of the end point of the same, the logical address of the start point of the third recording area, and the logical address of the end point of the same to the management information managing section 251, thereby obviating the necessity of ensuring the recording area in block S212 in the next loop recording session.

FIG. 9E shows that loop recording of contents into the second AV stream file 45 and continued normal recording performed subsequently to loop recording have ended. Since recording of the title PG #p has been completed, a new second recording area is ensured in the second AV stream file 45 for the next loop recording session. Further, a new third recording area used for continued normal recording performed continuously until completion of the next loop recording is ensured in the second AV stream file 45.

FIG. 9E adopts a mechanism for indicating the recorded AV data stream “c” and the AV data stream “d” by means of separate pieces of time map information. However, as described previously, there may also be adopted a mechanism for pointing out these data streams by means of one piece of time map information, and retaining information about the start point/end point of the recorded AV data stream separately and uniquely. Moreover, the system may also indicates the entirety of the recorded AV data streams c, d, e by means of a single piece of time map information and retaining information about the start point/end point of the recorded AV data stream separately and uniquely. In addition, a slight clearance exists between the last of the recorded AV data stream “d” and the head of the AV data stream “c,” but the clearance is not always required.

According to the recorder of the second embodiment, the additional area forming section 258 forms a third area to be subjected to normal recording subsequent to loop recording. For instance, the following manner of usage can be materialized. Namely, loop recording is commenced when the power of a TV set is turned on. A TV program that the user is watching is automatically recorded by means of loop recording without consciousness on the part of the user. When the user has started recording operation, loop recording is switched to normal recording. Thus, convenience for the user is enhanced. Even when the user has started recording the currently-watched TV program in midstream, scenes of the TV program preceding the scene where recording has been started have already been recorded through loop recording, thereby further enhancing convenience for the user.

In the recorder of the present embodiment, the management information 41 can commonly used for comprehensively managing both contents: the contents having been recorded by loop recording and continued to be recorded by normal recording subsequent to loop recording; and the contents recorded through normal recording. As a result, in the case of loop recording, storage of recorded contents and playback of stored contents for watching can be effected, so that convenience to the user is enhanced. In the recorder of this embodiment, the scenes recorded by loop recording and the scenes recorded by continued normal recording subsequent to loop recording are gathered under a single title, and can be comprehensively managed by means of the same management information as that used for the contents recorded through normal recording. For example, even when recording is started in midstream of the currently-watched TV program, scenes of the TV program preceding the scene, where recording has been started by the user with conscious on the part thereof, are also stored and can be played back later, thereby enhancing convenience to the user.

### Third Embodiment

By reference to FIG. 10, a recorder according to a third embodiment of the present invention will be described in detail. FIG. 10 is an exemplary block diagram showing the configuration of a recording management information control section 333 of the recorder of the third embodiment of the present invention. The recorder of the present embodiment is identical with the recorder 10 of the first embodiment, except that the recording management information control section 33 is replaced. Elements of the recorder common to the recorder of the first embodiment shown in FIGS. 1 through 3 are assigned corresponding reference numerals, and repeated explanations thereof are omitted.

As shown in FIG. 10, the recording management information control section 333 of the present embodiment includes: a management information managing section 351; an FS managing section 352; a recording scheme identification section 353; a recording area forming section 354; a recording area monitoring section 355; a normal recording section 356; a loop recording section 357; and a recording area movement section 359. The recorder of the present embodiment performs recording operation by means of the data recording configuration shown in FIG. 2A, namely, a configuration of separating an AV stream file for normal recording from an AV stream file for loop recording.

The FS managing section 352, the recording scheme identification section 353, the recording area monitoring section 355, and the normal recording section 356 have the same functions as those of the FS managing section 152, the recording scheme identification section 153, the recording area monitoring section 155, and the normal recording section 156, all of which pertain to the first embodiment. The management information managing section 351, the recording area forming section 354, and the loop recording section 357 correspond to the management information managing section 151, the recording area forming section 154, and the loop recording section 157, all of which pertain to the first embodiment. They differ from each other in that the recorder of the present embodiment has the function of forming a new second recording area for the purpose of loop recording and the recording area movement section 359 has the function of finally moving the data recorded through loop recording.

The recording area movement section 359 operates as a data movement unit configured to logically move the data recorded in the form of an AV data stream from one AV stream file to another AV stream file. The recording area movement section 359 has the function of moving a recorded AV data stream to the first AV stream file 44 after completion of loop recording and when the second AV stream file 45 is closed. Movement of the AV data stream is realized by changing logical address. Hence, actual movement of recording area is not carried out. When compared with a case where the AV data stream is merely moved, high-speed processing becomes feasible.

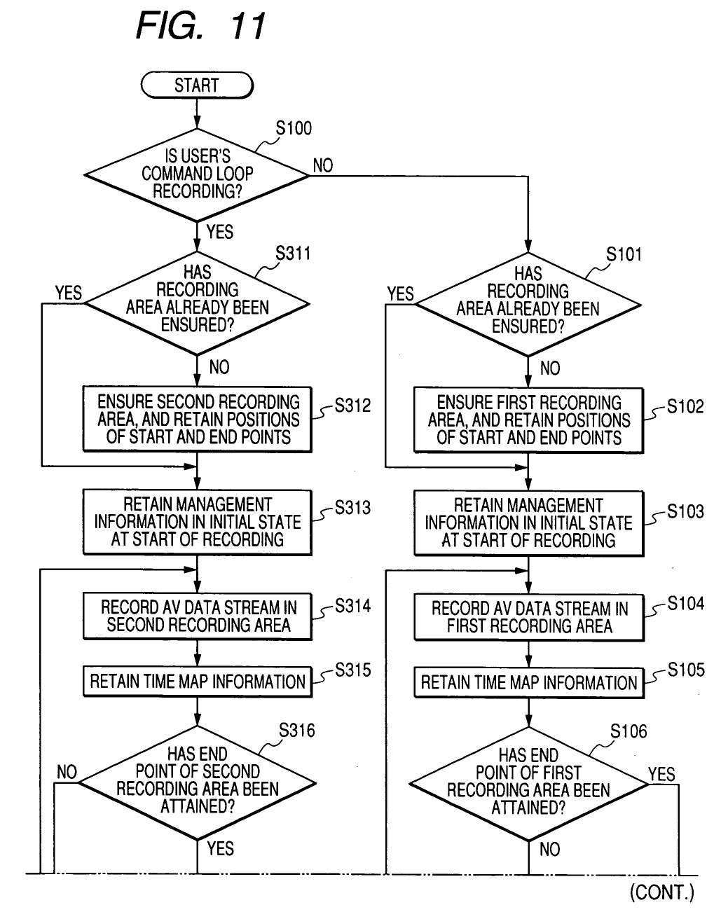

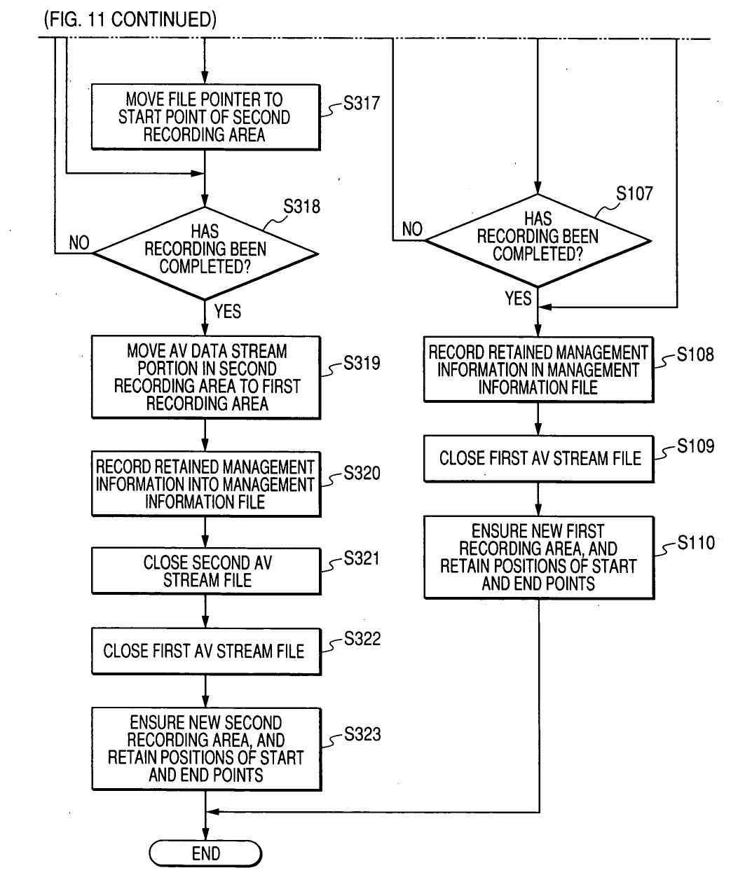

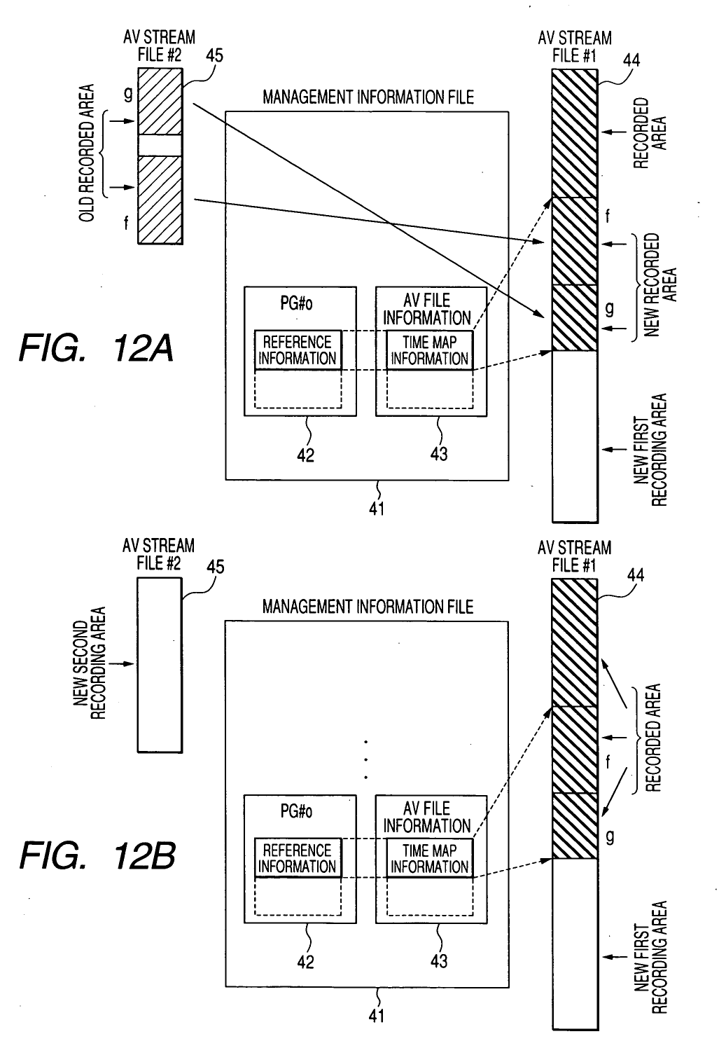

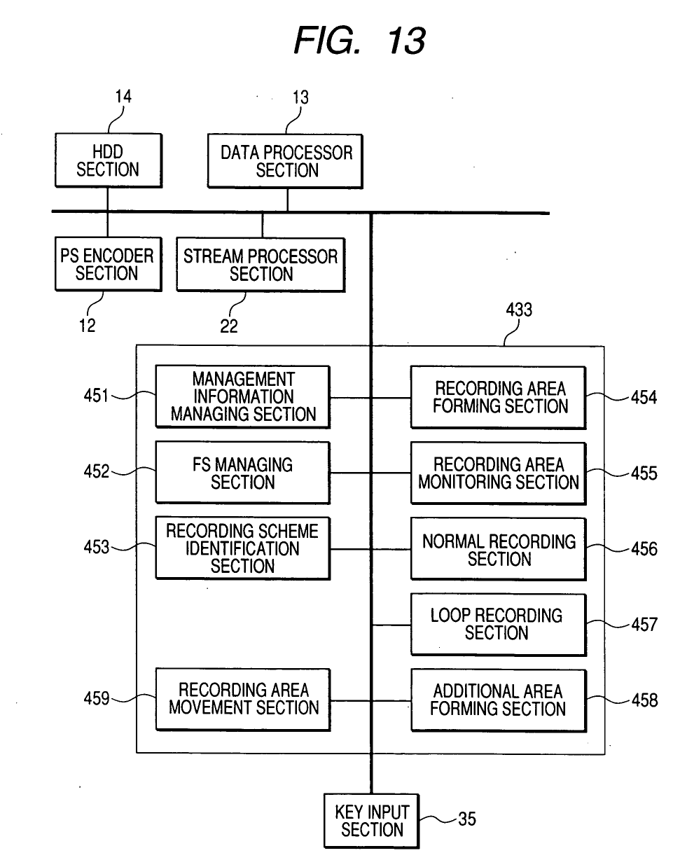

By reference to FIGS. 11, 12A, and 12B, operation of the recorder of the present embodiment will now be described. FIG. 11 is an exemplary flowchart showing operation of the recorder of the third embodiment, and FIGS. 12A and 12B are exemplary schematic diagrams showing recording operation performed during loop recording of the third embodiment. The recorder of the present embodiment is identical with that of the first embodiment in terms of normal recording operation. Consequently, descriptions of normal recording will be omitted.

The recorder of the present embodiment has a mechanism for shifting, after completion of loop recording, the area where the AV data stream has been recorded through loop recording, from the second recording area on the second AV stream file 45 to the first recording area on the first AV stream file 44 while ensuring consistency in playback sequence.

During loop recording, overwrite-recording which reuses a predetermined area many times is performed. Depending on a timing at which loop recording is stopped, the area where an AV data stream is to be recorded is sometimes partitioned into two areas where logical addresses are discontiguous. In a hard disk drive, since seeking operation of a head is performed at high speed, recording or playback is not greatly affected even in such a case. However, two pieces of time map information are required to indicate the respective two partitioned areas. Even when the areas are collected by means of a single piece of time map information, there is a necessity for additionally preparing auxiliary information showing the logical address of the start point of the recorded AV data stream and the logical address of the end point of the same, which makes the configuration of management information complicated. As mentioned above, by means of the mechanism of switching the second AV stream file 45 to the first AV stream file 44 while ensuring the consistency of playback sequence, the configuration of management information can be simplified, and the contents recorded through loop recording can be played back without use of auxiliary information.

When the user's instruction received from the key input section 35 signifies loop recording (YES in block S100 in FIG. 11), the recording scheme identification section 353 instructs the loop recording section 357 to perform loop recording. Upon receipt of the instruction for loop recording, the loop recording section 357 makes a query to the recording area monitoring section 355 as to whether or not the recording area for loop recording has been ensured (block S311). Upon receipt of the query, the recording area monitoring section 355 queries the FS managing section 352 as to whether a recording area for loop recording is ensured in the first AV stream file 44 or in the second AV stream file 45. In the present embodiment, loop recording is assigned to the second AV stream file 45, and hence in reply the FS managing section 352 provides, as the file system for loop recording purpose, the file system where the second AV stream file 45 is present. The recording area monitoring section 355 determines whether or not the second recording area for loop recording is ensured in the second AV stream file 45 of the file system provided by the FS managing section 352, and returns a result of determination to the loop recording section 357.

When the result of determination shows that the second recording area has not been ensured (NO in block S311), the loop recording section 357 instructs the recording area forming section 354 to ensure the second recording area. The recording area forming, section 354 forms the second recording area in the second AV stream file 45 of the HDD section 14, and returns to the loop recording section 357 the logical address of the start point of the second recording area and the logical address of the end point of the same (block S312).

When the result of determination shows that the second recording area has been ensured (YES in block S311) or that the recording area forming section 354 has ensured the second recording area, the loop recording section 357 generates management information 41 of initial state at the start of recording, and retains the management information in internal memory (block S313). More specifically, the loop recording section 357 instructs the management information managing section 351 to generate the management information 41 pertaining to the entire contents to be recorded from among the program group information 42, the reference information, and the AV file information 43. Upon receipt of the instruction, the management information managing section 351 receives, from the loop recording section 357, the logical address of the start point of the second recording area provided by the recording area forming section 354 and the logical address of the end point of the same. Then, the management information managing section 351 sets the logical addresses as time map information in the AV file information 43.

When the management information 41 is generated, the loop recording section 357 records the video data and the audio data, which are sent from the PS encoder section 12 or the stream processor section 22, in the second recording area ensured in the second AV data stream file 45 of the HDD section 14 (block S314). During the course of recording of the data into the second recording area, the management information managing section 351 generates, from moment to moment, time map information reflecting progress in recording of the AV data stream, and records the generated time map information into the AV file information 43 of the memory (block S315).

During recording operation of the loop recording section 357, the recording area monitoring section 355 monitors the state of the second recording area that is being recorded by the loop recording section 357, and reports the state to the loop recording section 357 (block S316). Specifically, the recording area monitoring section 355 determines a location up to which the AV data stream has been recorded in the recording medium (in the second AV stream file 45), based on the time map information generated by the management information managing section 351. Then, the recording area monitoring section 355 compares the determined position with the retained position of the end point of the second recording area (the logical address on the recording medium), thereby determining whether or not the end point of the second recording area has been achieved.

When the recording point of the loop recording section 357 is not the end point of the second recording area (NO in block S316), the loop recording section 357 determines whether or not recording has been completed. When recording has not been completed (NO in block S318), recording operation is continued (block S314). When the loop recording section 357 does not determine that recording has been completed, loop recording operation is continued, and repeated overwriting is performed in the second recording area.

When the recording point of the loop recording section 357 is the end point of the second recording area (YES in block S316), the loop recording section 357 moves a file pointer (a recording point) of the second AV stream file 45 to the position of the retained start point in the second recording area (a logical address on a recording medium) (block S317). That is, recording of a subsequent AV data stream is performed as overwrite-recording from the start point of the second recording area; therefore, there is performed overwrite-recording by means of which the inside of ensured second recording area is reused frequently, i.e., loop recording. When a loopback has arisen in the second recording area, the position of the start point in time map information, where recording of contents in the second AV data stream file 45 has started, must be adjusted. The management information managing section 351 shifts the position of the recording start point of a subsequent AV data stream backward in terms of time, by means of overwrite-recording.

When the loop recording section 357 has determined end of recording (YES in block S318), that is, when the user instructs recording of the data having been recorded through loop recording for storage purpose, the loop recording section 357 instructs the management information managing section 351 to complete recording. Upon receipt of the instruction, the management information managing section 351 records the management information 41, which has been recorded thus far, as a management information file in the first recording area of the HDD section 14 for the first AV stream file 44 (block S319), whereby the loop recording section 357 completes recording operation. Specifically, the management information managing section 351 switches the second recording area where the AV data stream has been recorded by means of loop recording, from the second AV stream file 45 to the first AV stream file 44 while ensuring the consistency of playback sequence. For instance, when a file system complying with UDF (Universal Disk Format) standards is used, the FS managing section 352 performs processing for shifting an extent corresponding to the area where the AV data stream is recorded, from a file entry of the second AV stream file 45 to a file entry of the first AV stream file 44. FIG. 12A is an exemplary view showing a state where the AV data stream recorded in the second recording area through loop recording is switched from the second AV stream file 45 to the first AV stream file 44 while ensuring consistency in playback sequence. Of the AV data streams recorded through loop recording, the AV data stream “f” is old, and the AV data stream “g” is new. In the second AV stream file 45, the AV data streams “f” and “g” are partitioned into two areas whose logical addresses are discontiguous, by means of a loopback loop recording. When the AV data streams “f” and “g” are switched to the first AV stream file 44, the AV data streams “f” and “g” are switched with each other in terms of sequence in such a way that the logical addresses become contiguous. As a result, time map information about the title PG#o is changed such that the AV data streams “f” and “g” indicate contiguous areas.

The management information managing section 351 changes the time map information about the data recorded through loop recording to a logical address achieved after movement of the first AV stream file 44 to the first recording area, and records the logical address (block S320). This signifies that the data recorded through loop recording are managed as data logically recorded through normal recording. A loopback having arisen in the second AV stream file 45 (partitioned portions of the AV data stream) is arranged in correct sequence and integrated into a single piece of time map information, and the integrated time map information is recorded.

When the management information 41 is recorded, the management information managing section 351 closes the first and second AV stream files 44 and 45 (block S321, block S322). As a result of the management information managing section 351 having recorded the management information file, the recorded area in the second AV stream file 45 is moved to the first AV stream file 44, and is set as a recorded area in the program group information 43 (as obliquely hatched by thick lines in FIG. 12A). The recorded area is brought under common management along with the recorded area of the first AV stream file 44 that has been recorded through normal recording.

Subsequently, the recording area forming section 354 newly forms first and second recording areas, and passes to the management information managing section 351 the logical address of the start point of the first recording area, the logical address of the end point of the same, the logical address of the start point of the second recording area, and the logical address of the endpoint of the same (block S323). At this time, the new second recording area can use the same area as that of the second recording area where recording operation has been performed thus far. In the next loop recording session, the necessity of ensuring the recording area in block S312 is obviated.

FIG. 12B shows that loop recording of contents into the second AV stream file 45 has ended. Since recording of the title PG #o has been completed and processing for switching the AV data stream recorded through loop recording from the second AV stream file 45 to the first AV stream file 44 has been completed, a new second recording area is ensured in the second AV stream file 45 for the next loop recording session. Further, a new first recording area is ensured in the first AV stream file 44 for the purpose of the next normal recording session.

As above, according to the recorder of the embodiment, the recording area movement section 359 moves the data recorded through loop recording to the first area for normal recording purpose. Hence, the configuration of management information can be simplified, and the contents recorded through loop recording can be played back without use of auxiliary information.

### Fourth Embodiment

By reference to FIG. 13, a recorder according to a fourth embodiment of the present invention will be described in detail. FIG. 13 is an exemplary block diagram showing the configuration of a recording management information control section 433 of the recorder of the fourth embodiment of the present invention. The recorder of the fourth embodiment is identical the recorder 10 of the first embodiment, except that the recording management information control section 33 is replaced. Elements of the recorder common to the recorder of the first embodiment shown in FIGS. 1 through 3 are assigned corresponding reference numerals, and repeated explanations thereof are omitted.

As shown in FIG. 13, the recording management information control section 433 of the present embodiment includes: a management information managing section 451; an FS managing section 452; a recording scheme identification section 453; a recording area forming section 454; a recording area monitoring section 455; a normal recording section 456; a loop recording section 457; an addition area forming section 458; and a recording area movement section 459. The recorder of the present embodiment performs recording operation by means of the data recording configuration shown in FIG. 2A, namely, a configuration of separating an AV stream file for normal recording from an AV stream file for loop recording.

The FS managing section 452, the recording scheme identification section 453, and the normal recording section 456 have the same functions as those of the FS managing section 152, the recording scheme identification section 153, and the normal recording section 156, all of which pertain to the first embodiment. The management information managing section 451, the recording area forming section 454, the recording area monitoring section 455, the loop recording section 457, and the additional area forming section 458 correspond to the management information managing section 251, the recording area forming section 254, the recording area monitoring section 255, the loop recording section 257, and the additional area forming section 258, all of which pertain to the second embodiment. They differ from each other in that the recorder of the present embodiment has the function of finally moving the data recorded through loop recording and the function of forming new second and third recording areas for loop recording.

The recording area movement section 459 corresponds to the recording area movement section 359 of the third embodiment. Specifically, the recorder of the present embodiment is realized by means of adding the AV data stream movement function to the recorder of the second embodiment.

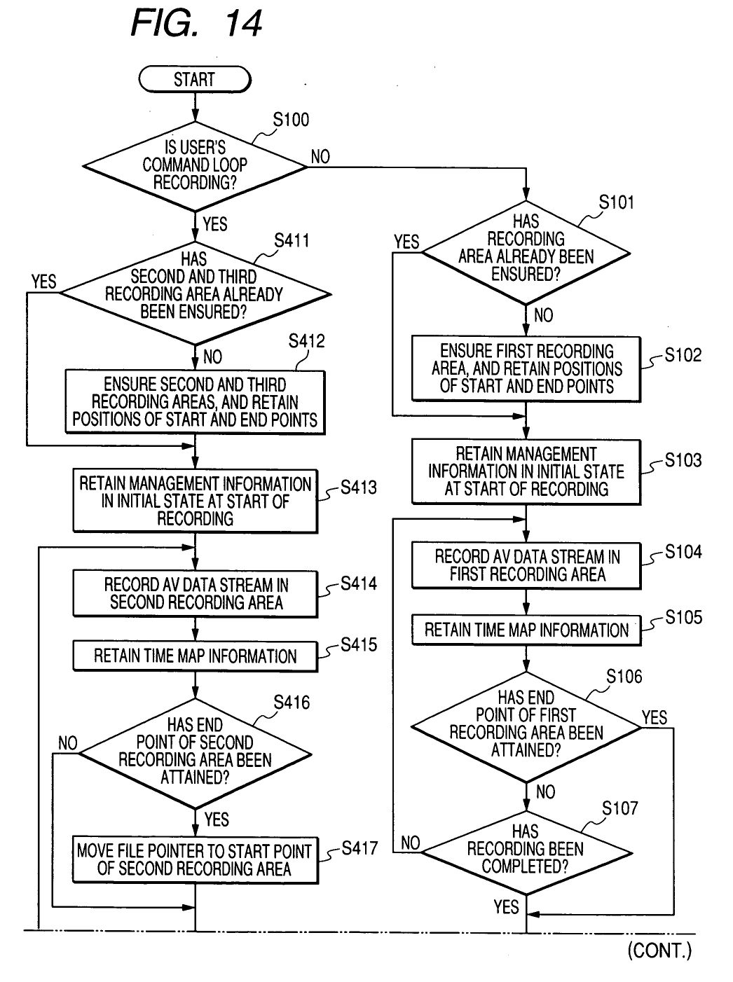

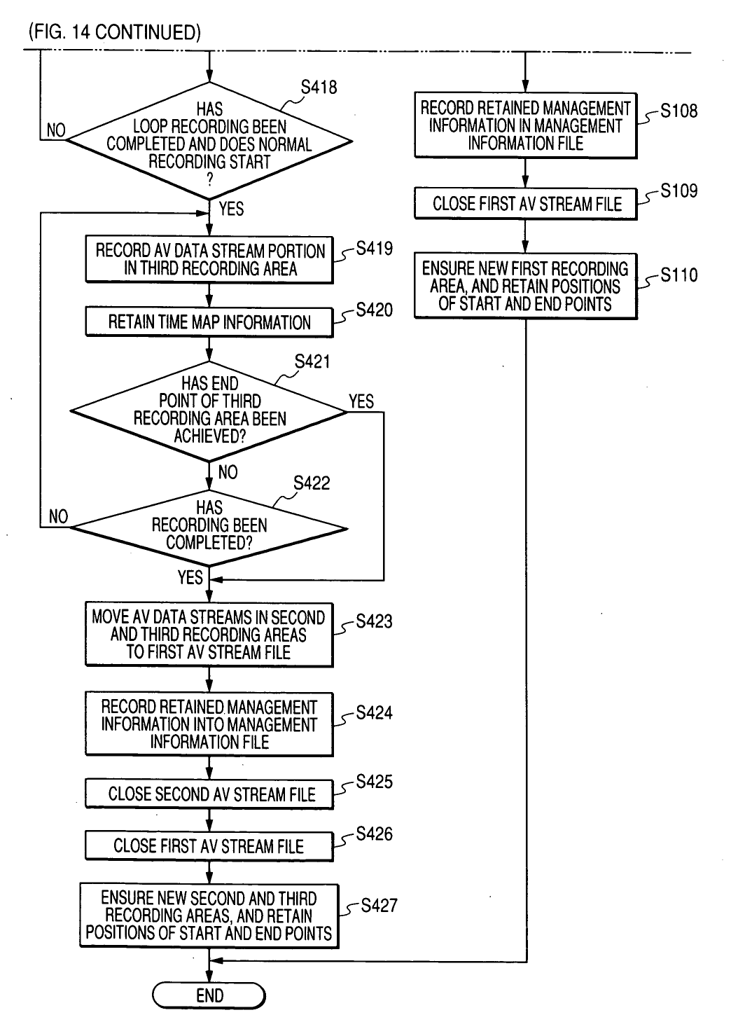

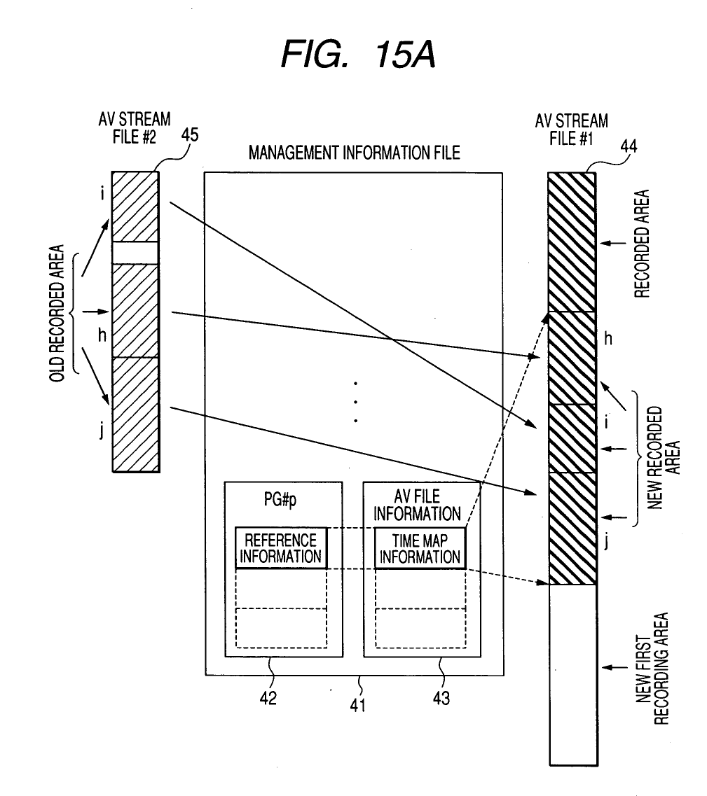

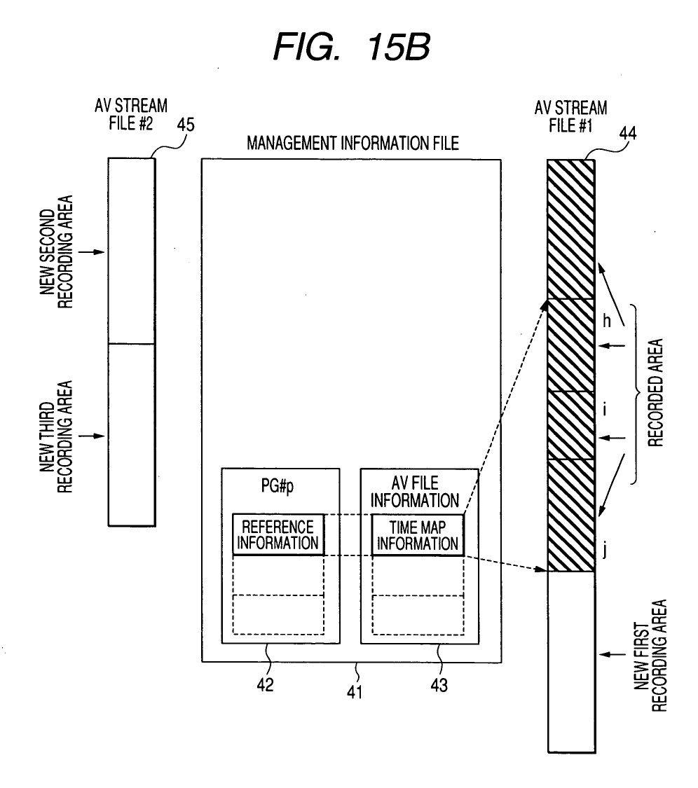

By reference to FIGS. 14, 15A, and 15B, operation of the recorder of the present embodiment will now be described. FIG. 14 is an exemplary flowchart showing operation of the recorder of the present embodiment, and FIGS. 15A and 15B are exemplary schematic diagrams showing recording operation performed during loop recording of the present embodiment. The recorder of the present embodiment is identical with that of the first embodiment in terms of normal recording operation. Consequently, descriptions of normal recording will be omitted.

When the key input section 35 has received an instruction from the user, the recording scheme identification section 453 determines whether or not the user's instruction signifies loop recording (block S100 in FIG. 14). When the user's instruction is normal recording (NO in block S100), subsequent operations are the same as those of the first embodiment, and hence their explanations are omitted.

When the user's instruction received from the key input section 35 is loop recording (YES in block S100), the recording scheme identification section 453 instructs the loop recording section 457 to perform loop recording. Upon receipt of the instruction for loop recording, the loop recording section 457 makes a query to the recording area monitoring section 455 as to whether or not the recording area for loop recording has been ensured (block S411). Upon receipt of the query, the recording area monitoring section 455 queries the FS managing section 452 as to whether a recording area for loop recording is ensured in the first AV stream file 44 or in the second AV stream file 45. In the present embodiment, loop recording is assigned to the second AV stream file 45, and hence in reply the FS managing section 452 provides, as the file system for loop recording purpose, the file system where the second AV stream file 45 is present. The recording area monitoring section 455 determines whether or not the second recording area and the third recording area are ensured, as the recording area for loop recording, in the second AV stream file 45 of the file system provided by the FS managing section 452. Then, the recording area monitoring section 455 returns a result of determination to the loop recording section 457.

When the result of determination shows that the second and third recording areas have not been ensured (NO in block S411), the loop recording section 457 instructs the recording area forming section 454 and the additional area forming section 458 to ensure the second and third recording areas. The recording area forming section 454 forms the second recording area in the second AV stream file 45 of the HDD section 14, and returns to the loop recording section 457 the logical address of the start point of the second recording area and the logical address of the end point of the same. Likewise, the additional area forming section 458 forms the third recording area at a position following the second recording area of the second AV stream file 45, and returns to the loop recording section 457 the logical address of the start point of the third recording area and the logical address of the end point of the same (block S412).

When the result of determination shows that the second and third recording areas has been ensured (YES in block S411) or that the recording area forming section 454 and the additional area forming section 458 have ensured the second and third recording areas, the loop recording section 457 generates management information 41 of initial state at the start of recording, and retains the management information in internal memory (block S413). More specifically, the loop recording section 457 instructs the management information managing section 451 to generate management information 41 pertaining to the entire contents to be recorded from among the program group information 42, the reference information, and the AV file information 43. Upon receipt of the instruction, the management information managing section 451 receives, from the loop recording section 457, the logical address of the start point of the second recording area provided by the recording area forming section 454, the logical address of the end point of the same, the logical address of the start point of the third recording area provided by the additional area forming section 458, and the logical address of the end point of the same. Then, the management information managing section 451 sets the logical addresses as time map information in the AV file information 43.

When the management information 41 is generated, the loop recording section 457 records the video data and the audio data, which are sent from the PS encoder section 12 or the stream processor section 22, in the second recording area ensured in the second AV data stream file 45 of the HDD section 14 (block S414). During the course of recording of the data into the second recording area, the management information managing section 451 generates, from moment to moment, time map information reflecting progress in recording of the AV data stream, and records the generated time map information into the AV file information 43 of the memory (block S415).

During recording operation of the loop recording section 457, the recording area monitoring section 455 monitors the state of the second recording area that is being recorded by the loop recording section 457, and reports the state to the loop recording section 457 (block S416). Specifically, the recording area monitoring section 455 determines a location up to which the AV data stream has been recorded in the recording medium (in the second AV stream file 45), based on the time map information generated by the management information managing section 451. The recording area monitoring section 455 compares the determined position with the retained position of the end point of the second recording area (the logical address on the recording medium), thereby determining whether or not the end point of the second recording area has been achieved.

When the recording point of the loop recording section 457 is not the end point of the second recording area (NO in block S416), the loop recording section 457 determines whether or not recording has been completed. When recording has not been completed (NO in block S418), recording operation is continued (block S414).

When the recording point of the loop recording section 457 is the end point of the second recording area (YES in block S416), the loop recording section 457 moves a file pointer (a recording point) of the second AV stream file 45 to the position of the retained start point in the second recording area (a logical address on a recording medium) (block S417). That is, recording of a subsequent AV data stream is performed as overwrite-recording from the start point of the second recording area; therefore, there is performed overwrite-recording by means of which the inside of ensured second recording area is reused, i.e., loop recording. When a loopback has arisen in the second recording area, the position of the start point in time map information, where recording of contents in the second AV data stream file 45 has started, must be adjusted. The management information managing section 451 shifts the position of the recording start point of a subsequent AV data stream backward in terms of time, by means of overwrite-recording.

When the loop recording section 457 has determined end of recording and the start of normal recording (YES in block S418), the loop recording section 457 provides the management information managing section 451 with an instruction about the end of loop recording and the start of normal recording. Upon receipt of the instruction, the management information managing section 451 records the management information 41, which has been recorded thus far, in the HDD section 14 as a management information file. The loop recording section 457 shifts a file pointer to the start point of the third recording area, thereby continuously performing recording operation as normal recording (block S419). The management information managing section 451 receives, from the loop recording section 457, the logical address of the start point of the third recording area and the logical address of the end point of the same. Then, the management information managing section 451 sets new time map information in the AV file information 43; the new time map information corresponds to recording of data into the third recording area (block S420). The data recorded in the third recording area are recorded through normal recording and are not overwritten.

During recording operation of the loop recording section 457, the recording area monitoring section 455 monitors the state of the third recording area that is being successively recorded by the loop recording section 457, and reports the state of the third recording area to the loop recording section 457 (block S421). Specifically, the recording area monitoring section 455 determines a location up to which the AV data stream has been recorded in the recording medium (in the second AV stream file 45), based on the time map information generated by the management information managing section 451. Then, the recording area monitoring section 455 compares the determined location with the retained position of the end point of the third recording area (the logical address on the recording medium), thereby determining whether or not the end point of the third recording area has been achieved.

When the recording point of the loop recording section 457 is not the end point of the third recording area (NO in block S421), the loop recording section 457 determines whether or not recording has been completed. When recording has not been completed (NO in block S422), recording operation is continued (block S419).

When the recording point of the loop recording section 457 is the end point of the third recording area (YES in block S421) or when the loop recording section 457 determines that recording has ended, the loop recording section 457 provides the management information managing section 451 with an instruction concerning the completion of recording. Upon receipt of the instruction, the management information managing section 451 records the management information 41, which has been recorded thus far, as a management information file corresponding to the first recording area of the first AV stream file 44 in the HDD section 14 (block S423), whereby the loop recording section 457 completes recording operation. Specifically, the management information managing section 451 switches the second recording area where the AV data stream has been recorded by means of loop recording, from the second AV stream file 45 to the first AV stream file 44 while ensuring the consistency of playback sequence. For instance, when a file system complying with UDF (Universal Disk Format) standards is used, the FS managing section 452 performs processing for shifting an extent corresponding to the area where the AV data stream is recorded, from a file entry of the second AV stream file 45 to a file entry of the first AV stream file 44.

FIG. 15A is an exemplary view showing a state where the AV data stream recorded in the second recording area through loop recording and the AV data stream recorded in the third recording area through normal recording started subsequent to the end of the loop recording are switched from the second AV stream file 45 to the first AV stream file 44 while ensuring consistency in playback sequence. Of the AV data streams recorded through loop recording, the AV data stream “h” is old, and the AV data stream “i” is new. In the second AV stream file 45, the AV data streams “h” and “i” are partitioned into two areas whose logical addresses are discontiguous, by means of a loopback loop recording. The AV data stream recorded through normal recording is the AV data stream “j” recorded following the AV data stream “i.” However, the logical addresses of the AV data streams “i” and “j” are discontiguous. When the AV data streams “h” and “i” are switched to the first AV stream file 44, the AV data streams “h” and “i” are switched with each other in terms of sequence in such a way that the logical addresses become contiguous. As a result, time map information about the title PG#p is changed such that the AV data streams “h” and “i” indicate contiguous areas.

The management information managing section 451 changes the time map information about the data recorded through loop recording to a logical address achieved after movement of the first AV stream file 44 to the first recording area, and records the logical address (block S424). This signifies that the data recorded through loop recording are managed as data logically recorded through normal recording. A loopback having arisen in the second AV stream file 45 (partitioned portions of the AV data stream) is arranged in correct sequence and integrated into a single piece of time map information, and the integrated time map information is recorded.

When the management information 41 is recorded, the management information managing section 451 closes the first and second AV stream files 44 and 45 (block S425, block S426). As a result of the management information managing section 451 having recorded the management information file, the recorded area in the second AV stream file 45 is moved to the first AV stream file 44, and is set as a recorded area in the program group information 42 (as obliquely hatched by thick lines in FIG. 15B). The recorded area is brought under common management along with the recorded area of the first AV stream file 44 that has been recorded through normal recording.

Subsequently, the recording area forming section 454 newly forms second and third recording areas, and passes to the management information managing section 451 the logical address of the start point of the second recording area, the logical address of the endpoint of the same, the logical address of the start point of the third recording area, and the logical address of the end point of the same (block S427). At this time, the new second and third recording areas can use the same areas as those of the second and third recording areas where recording operation has been performed thus far. In the next normal recording session, the necessity of ensuring the recording area in block S412 is obviated.

FIG. 15B shows that loop recording of contents into the second AV stream file 45 has ended. Since recording of the title PG #p has been completed and processing for switching the AV data stream recorded through loop recording from the second AV stream file 45 to the first AV stream file 44 has been completed, new second and third recording areas are ensured in the second AV stream file 45 for the next loop recording session. Further, a new first recording area is ensured in the first AV stream file 44 for the purpose of the next normal recording session.

### Fifth Embodiment

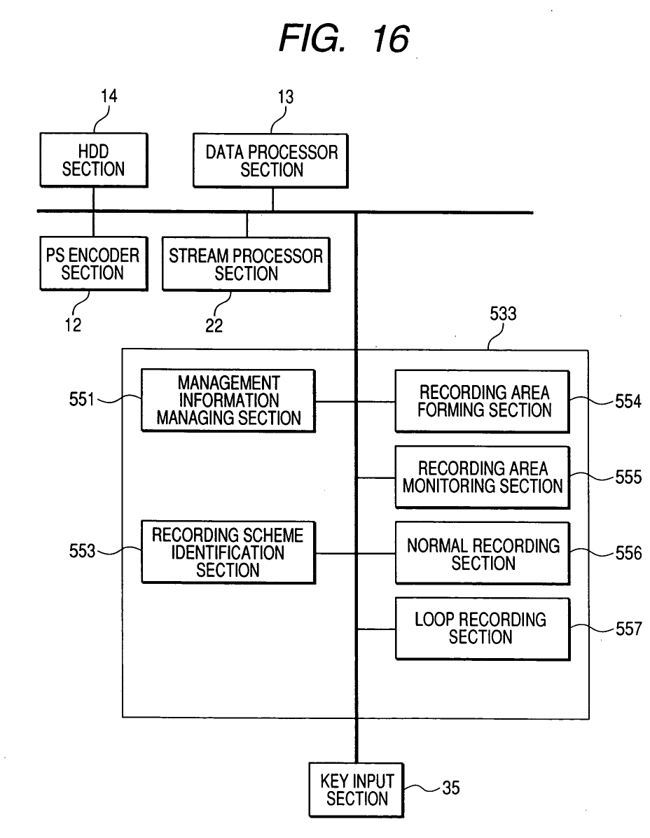

By reference to FIG. 16, a recorder according to a fifth embodiment of the present invention will be described in detail. FIG. 16 is an exemplary block diagram showing the configuration of a recording management information control section 533 of the recorder of the fifth embodiment of the present invention. The recorder of the present embodiment is equal to the recorder 10 of the first embodiment, except that only the recording management information control section 33 is replaced. The configuration of the recorder common to the recorder of the first embodiment shown in FIGS. 1 through 3 is assigned the same reference numeral, and repeated explanations thereof are omitted.

As shown in FIG. 16, the recording management information control section 533 of the present embodiment includes: a management information managing section 551; a recording scheme identification section 553; a recording area forming section 554; a recording area monitoring section 555; a normal recording section 556; and a loop recording section 557. The recorder of the present embodiment performs recording operation by means of the data recording configuration shown in FIG. 2B, namely, a recording configuration of taking an AV stream file for normal recording and an AV stream file for loop recording as an identical stream file.

The management information managing section 551, the recording scheme identification section 553, the recording area forming section 554, the recording area monitoring section 555, the normal recording section 556, and the loop recording section 557 correspond to the management information managing section 151, the recording scheme identification section 153, the recording area forming section 154, the recording area monitoring section 155, the normal recording section 156, and the loop recording section 157, all of which pertain to the first embodiment. The recorder of the fifth embodiment implements normal recording and loop recording by means of only the AV stream file 46.

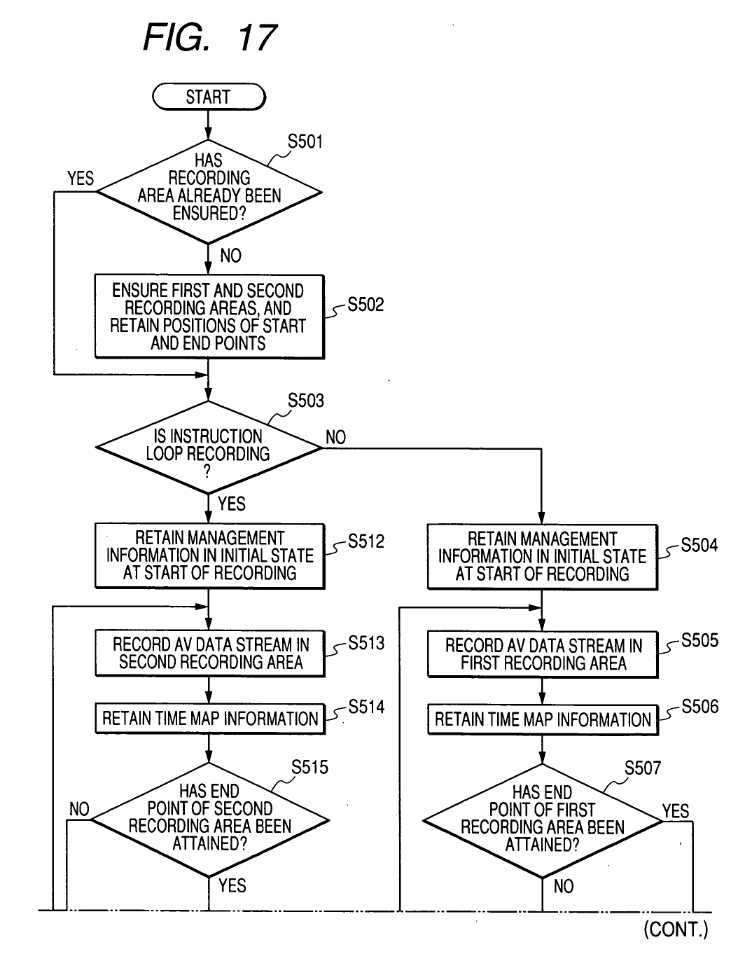

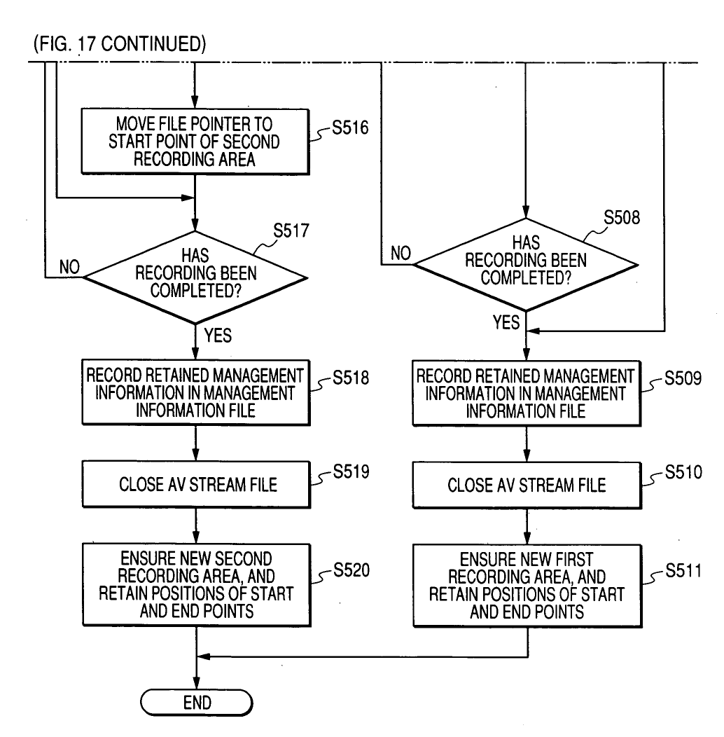

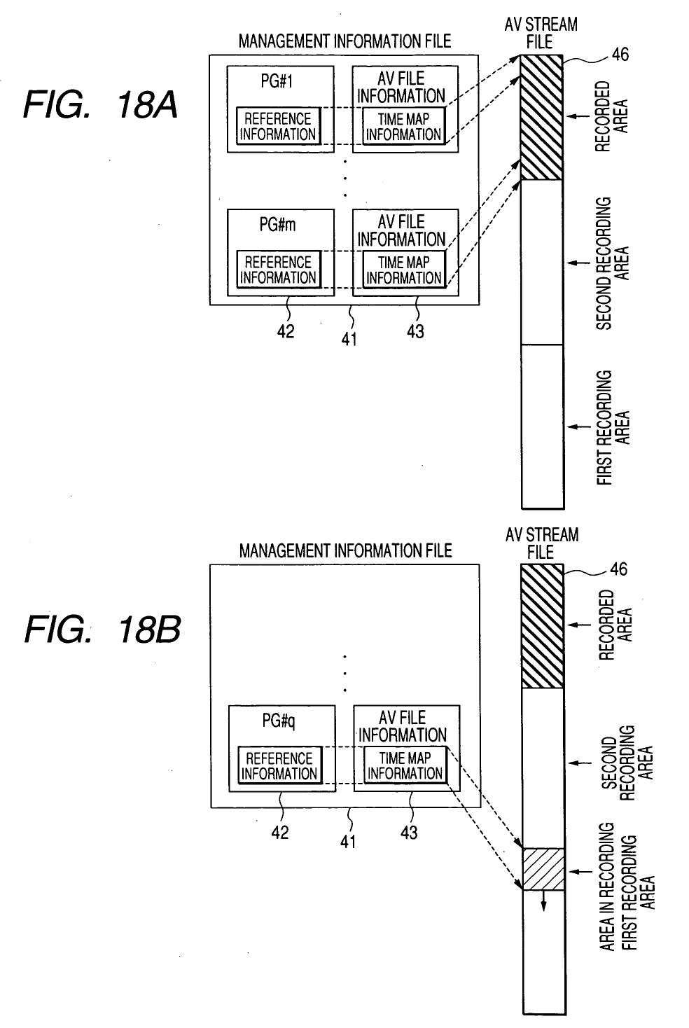

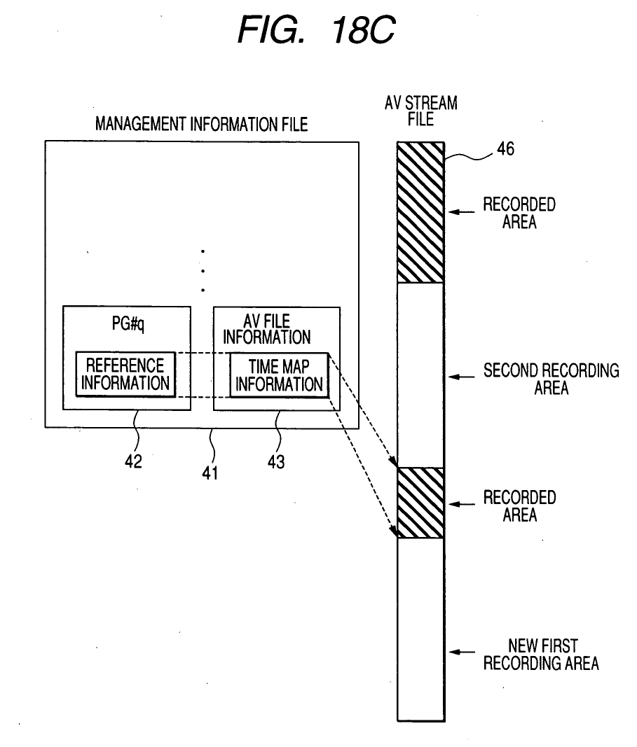

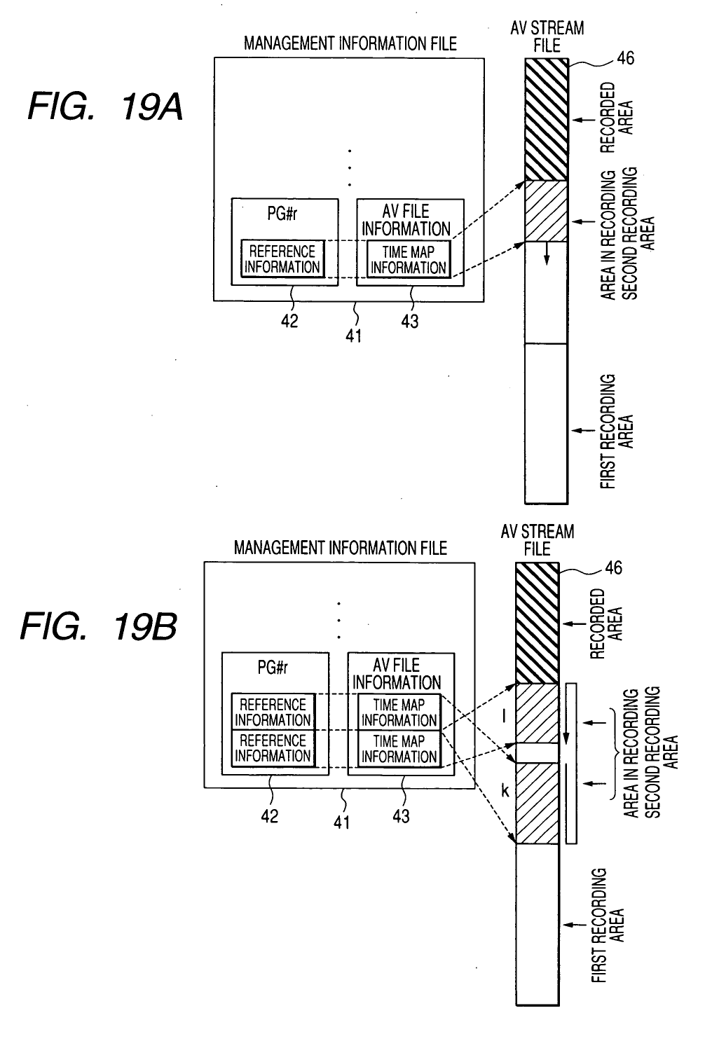

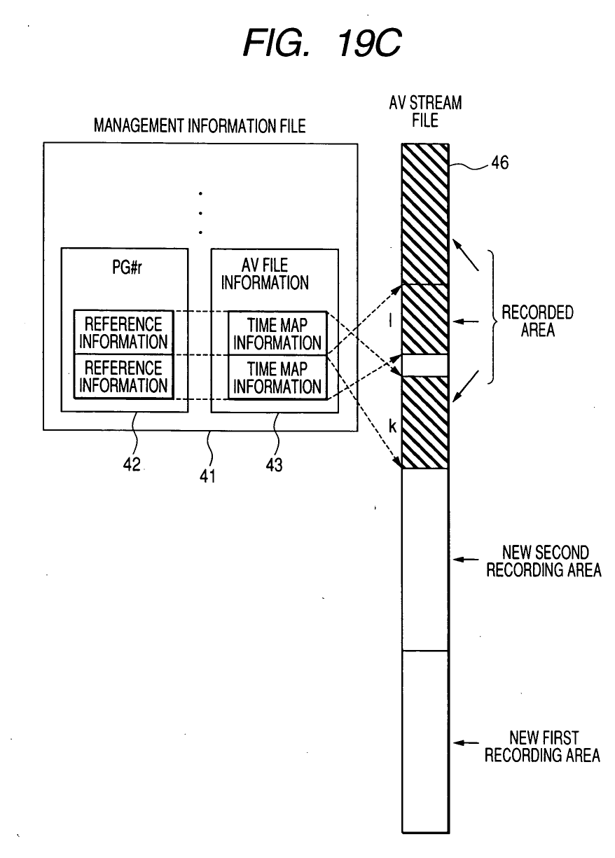

By reference to FIGS. 17, 18A to 18C, and 19A to 19C, operation of the recorder of the present embodiment will now be described. FIG. 17 is an exemplary flowchart showing operation of the recorder of the present embodiment, FIGS. 18A to 18C are exemplary schematic diagrams showing recording operation performed during normal recording of the present embodiment, and FIGS. 19A to 19C are exemplary schematic diagrams showing recording operation performed during loop recording of the present embodiment.

First, FIG. 18A shows the management information 41 and an AV stream file 46, all of which are in an initial state. As shown in FIG. 18A, in the AV stream file 46, a second recording area for loop recording is ensured at a position continuing from the recorded area. Meanwhile, in the AV stream file 46, a first recording area for normal recording is ensured at a position continuing from a second recording area. In the embodiment shown in FIG. 18A, titles from PG#1 to PG#m have already been recorded as the program group information 42 recorded through normal recording, and the recorded area is formed in the AV stream file 46 (an area diagonally shaded by thick lines in FIG. 18A). These notations are omitted in subsequent descriptions for convenience.

In the recorder of the embodiment, the recording area monitoring section 555 monitors, at all times, whether or not the first and second recording areas are ensured (block S501 in FIG. 17). When the first and second recording areas are not ensured (NO in block S501), the recording area monitoring section 555 provides the recording area forming section 554 with an instruction for generating a first recording area for normal recording and a second recording area for loop recording. The recording area forming section 554 sequentially forms the second recording area and the first recording area subsequent to the end point of the recorded area (block S502).

When the first and second recording areas have already been ensured (YES in block S501) or the recording area forming section 554 has formed the first and second recording areas, the recording scheme identification section 553 waits for an instruction from the user (block S503). When the key input section 35 has received the instruction from the user, the recording scheme identification section 553 determines whether or not the user's instruction is loop recording.

When the user's instruction is normal recording (NO in block S503), the recording scheme identification section 553 provides the normal recording section 556 with an instruction for normal recording. Upon receipt of the instruction for normal recording, the normal recording section 556 generates management information of initial state at the start of recording, and retains the management information in internal memory (block S504). More specifically, the normal recording section 556 instructs the management information managing section 551 to generate the management information 41 pertaining to the entire contents to be recorded from among the program group information 42, the reference information, and the AV file information 43. Upon receipt of the instruction, the management information managing section 551 receives, from the normal recording section 556, the logical address of the start point of the first recording area and the logical address of the end point of the same. Then, the management information managing section 551 sets the logical addresses as time map information in the AV file information 43.

When the management information 41 is generated, the normal recording section 556 records the video data and the audio data, which are sent from the PS encoder section 12 or the stream processor section 22, in the first recording area ensured in the AV data stream file 46 of the HDD section 14 (block S505).

During the course of recording of the data into the first recording area, the management information managing section 551 generates, from moment to moment, time map information reflecting a progress in recording of the AV data stream, and records the generated time map information into the AV file information 43 of the memory (block S506). FIG. 18B shows that contents are recorded in the first recording area of the AV stream file 46 through normal recording. In FIG. 18B, contents are recorded through normal recording under a new title PG#q. As shown in FIG. 18B, the AV data stream (as diagonally hatched by fine lines), which is to be recorded through normal recording, is recorded in the first recording area. The time map information, which is management information, corresponds to the AV data stream recorded in the first recording area.

During recording operation of the normal recording section 556, the recording area monitoring section 555 monitors, the state of the first recording area that is being recorded by the normal recording section 556, and reports the state to the normal recording section 556 (block S507). Specifically, the recording area monitoring section 555 determines a location up to which the AV data stream has been recorded in the recording medium (in the AV stream file 46), based on the time map information generated by the management information managing section 551. Then, the recording area monitoring section 555 compares the determined position with the retained position of the endpoint of the first recording area (the logical address on the recording medium), thereby determining whether or not the end point of the first recording area has been achieved.

When the recording point of the normal recording section 556 is not the end point of the first recording area (NO in block S507), the normal recording section 556 determines whether or not recording has been completed. When recording has not been completed (NO in block S508), recording operation is continued (block S505).

When the recording point of the normal recording section 556 is the end point of the first recording area (YES in block S507) or the normal recording section 556 has determined that recording has ended (YES in block S508), the normal recording section 556 provides the management information managing section 551 with an instruction for completion of recording. Upon receipt of the instruction, the management information managing section 551 records the management information 41, which has been recorded thus far, in the HDD section 14 as a management information file (block S509), whereby the normal recording section 556 completes recording operation, and the management information managing section 551 closes the AV stream file 46 (block S510).

Subsequently, the recording area forming section 154 forms a new first recording area, and passes the logical address of a starting point of the first recording area and the logical address of an end point of the same to the management information managing section 551 (block S511), thereby obviating the necessity of ensuring the recording area in block S502 in the next normal recording session. FIG. 18C shows that normal recording of contents into the AV stream file 46 has ended. Here, since recording of the title PG #q has completed (as diagonally hatched by thick lines), a new first recording area is ensured in the AV stream file 46 for the next normal recording operation.

When the user's instruction received by way of the key input section 35 is loop recording (YES in block S503), the recording scheme identification section 553 provides the loop recording section 557 with an instruction for loop recording. Upon receipt of the instruction for loop recording, the loop recording section 557 generates management information 41 of initial state at the start of recording, and retains the management information in internal memory (block S512). More specifically, the loop recording section 557 instructs the management information managing section 551 to generate the management information 41 pertaining to the entire contents to be recorded from among the program group information 42, the reference information, and the AV file information 43. Upon receipt of the instruction, the management information managing section 551 receives, from the loop recording section 557, the logical address of the start point of the second recording area and the logical address of the end point of the same. Then, the management information managing section 551 sets the logical addresses as time-map information in the AV file information 43.

When the management information 41 is generated, the loop recording section 557 records the video data and the audio data, which are sent from the PS encoder section 12 or the stream processor section 22, in the second recording area ensured in the AV data stream file 46 in the HDD section 14 (block S513). During the course of recording of the data into the second recording area, the management information managing section 551 generates, from moment to moment, time map information reflecting a progress in recording of the AV data stream, and records the generated time map information into the AV file information 43 of the memory (block S514).

FIG. 19A shows that contents are recorded in the second recording area of the AV stream file 46 through loop recording. In FIG. 19A, contents are recorded through loop recording under a new title PG#r. As shown in FIG. 19A, the AV data stream (as diagonally hatched by fine lines), which is to be recorded through loop recording, is recorded in the second recording area. The time map information, which is management information, corresponds to the AV data stream recorded in the second recording area.

During recording operation of the loop recording section 557, the recording area monitoring section 555 monitors the state of the second recording area that is being recorded by the loop recording section 557 (block S515). Specifically, the recording area monitoring section 555 determines a location up to which the AV data stream has been recorded in the recording medium (in the AV stream file 46), based on the time map information generated by the management information managing section 551. Then, the recording area monitoring section 555 compares the determined position with the retained position of the end point of the second recording area (the logical address on the recording medium), thereby determining whether or not the end point of the second recording area has been achieved.

When the recording point of the loop recording section 557 is not the end point of the second recording area (NO in block S515), the loop recording section 557 determines whether or not recording has been completed. When recording has not been completed (NO in block S517), recording operation is continued (block S513). When the loop recording section 557 does not determine that recording has been completed, loop recording operation is continued, and repeated overwriting is performed in the second recording area.

When the recording point of the loop recording section 557 is the end point of the second recording area (YES in block S515), the loop recording section 557 moves a file pointer (a recording point) of the AV stream file 46 to the position of the retained start point in the second recording area (a logical address on a recording medium) (block S516). Thereby, recording of a subsequent AV data stream is performed as overwrite-recording from the start point of the second recording area, whereby overwrite-recording by means of which the inside of ensured second recording area is reused frequently, namely, loop recording, is performed. When a loopback has arisen in the second recording area, the position of the recording start point in time map information, where recording of contents in the AV data stream file 46 has started, must be adjusted. The management information managing section 551 shifts the position of the start point of a subsequent AV data stream backward in terms of time, by means of overwrite-recording.

FIG. 19B shows that a loopback has arisen in the second recording area during the course of loop recording of contents into the AV stream file 46. Among the AV data streams recorded through loop recording, an AV data stream “k” in the drawing is old in terms of time. Since the end of the AV data stream “k” has reached the end point of the second recording area, the file pointer of the AV stream file 46 is reset to the start point of the second recording area, whereby a subsequent portion is recorded as an AV data stream “l.” At that time, the AV data stream “l” is sequentially recorded in an overwriting manner from a position preceding the head of the AV data stream “k.” Accordingly, in association with overwrite-recording of the AV data stream “l,” the time map information indicating the AV data stream “k” shifts the position of the start point of the indicated AV data stream “k.”

In FIG. 19B, a point of connection between the AV data stream “k” and the AV data stream “l” is made discontiguous as a result of occurrence of a loopback. Therefore, pieces of time map information indicating respective AV data streams are provided separately. However, the present embodiment is not limited to such time map information. For instance, there may also be adopted a mechanism for pointing out the entire second recording area by means of one piece of time map information, and retaining information about the start point/end point of the recorded AV data stream separately, uniquely. In FIG. 19B, slight clearance exists between the last of the AV data stream “l” and the head of the AV data stream “k,” but the clearance is not always indispensable.

When the loop recording section 557 has determined end of recording (YES in block S517), namely, when the user instructs recording of the data having been recorded through loop recording for storage purpose, the loop recording section 557 instructs the management information managing section 451 to complete recording. Upon receipt of the instruction, the management information managing section 451 records the management information 41, which has been recorded thus far, in the HDD section 14 as a management information file (block S518). The loop recording section 557 completes recording operation, and the management information managing section 551 closes the AV stream file 46 (block S519). As a result of the management information managing section 551 having recorded the management information file, the recorded area of the AV stream file 46 where recording has been completed is set in the program group information 42 as a recorded area (as obliquely hatched by thick lines in FIG. 19C). The recorded area is brought under common management along with the recorded area of the AV stream file 46 that has been recorded through normal recording.

Subsequently, the recording area forming section 554 newly forms a new second recording area and a new first recording area, and passes the logical address of the start point of the new second recording area, the logical address of the end point of the same, the logical address of the start point of the new first recording area, the logical address of the end point of the same to the management information managing section 551 (block S520), thereby obviating the necessity of ensuring the recording area in block S502 in the next normal recording session. FIG. 19C shows that loop recording of contents into the AV stream file 46 has ended. Here, since recording of the title PG #r has completed, new first and second recording areas are ensured in the AV stream file 46 for the next loop recording session. FIG. 19C adopts a mechanism for indicating the recorded AV data stream “k” and the AV data stream “l” by means of separate pieces of time map information. However, as described in connection with FIG. 19B, there may also be adopted a mechanism for pointing out the these data streams by means of one piece of time map information, and retaining information about the start point/end point of the recorded AV data stream separately, uniquely. In addition, slight clearance exists between the last of the recorded AV data stream “l” and the head of the AV data stream “k,” but the clearance is not always indispensable.

As mentioned above, according to the recorder of the present embodiment, the management information managing section 551 manages the management information about normal recording and the management information about loop recording by means of the common program group information 42 and the AV file information 43. Hence, the management information can be provided to the user as program information without making a distinction between normal recording and loop recording.

Further, according to the recorder of the present embodiment, the loop recording section 557 instructs completion of recording, whereby loop-recorded data are stored as a recorded area serving as storage data. Hence, even in the case of loop-recorded data, the data can be recorded as storage data which is not subjected to overwriting.

Further, according to the recorder of the present embodiment, the recording area forming section 554 ensures a new second recording area for the next loop recording session and a new first recording area for a normal recording session after completion of loop recording. Hence, loop-recorded data are not subjected to overwriting and can be permanently stored as in the case of normal recording.

### Sixth Embodiment

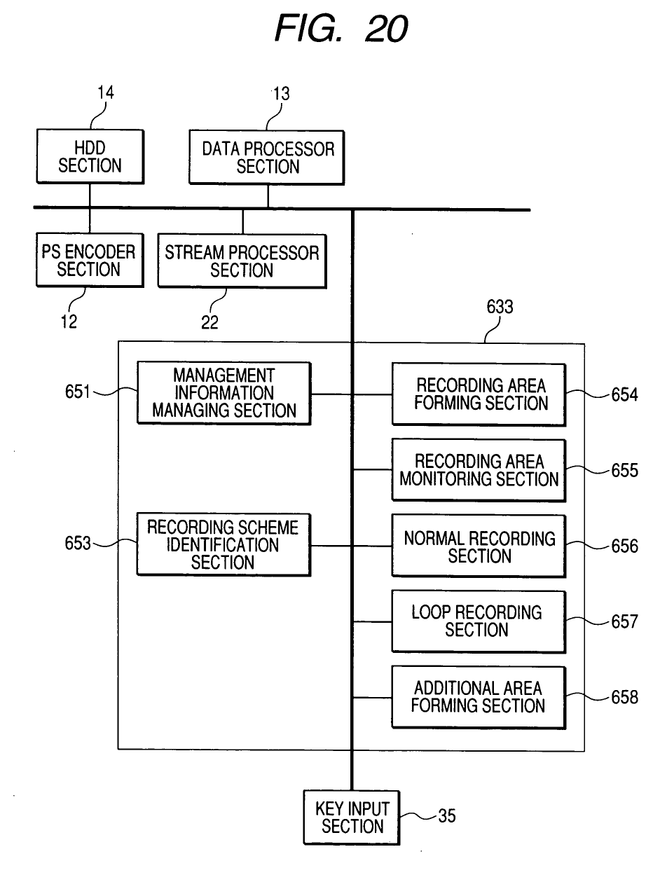

By reference to FIG. 20, a recorder according to a sixth embodiment of the present invention will be described in detail. FIG. 20 is an exemplary block diagram showing the configuration of a recording management information control section 633 of the recorder of the sixth embodiment of the present invention. The recorder of the present embodiment is equal to the recorder 10 of the first embodiment, except that only the recording management information control section 33 is replaced. The configuration of the recorder common to the recorder of the first embodiment shown in FIGS. 1 through 3 is assigned the same reference numeral, and repeated explanations thereof are omitted.

As shown in FIG. 20, the recording management information control section 633 of the present embodiment includes: a management information managing section 651; a recording scheme identification section 653; a recording area forming section 654; a recording area monitoring section 655; a normal recording section 656; a loop recording section 657; and an additional region forming section 658. The recorder of the present embodiment performs recording operation by means of the data recording configuration shown in FIG. 2B, namely, a recording configuration of taking an AV stream file for normal recording and an AV stream file for loop recording as an identical stream file.

The management information managing section 651, the recording scheme identification section 653, the recording area forming section 654, the recording area monitoring section 655, the normal recording section 656, and the loop recording section 657 correspond to the management information managing section 151, the recording scheme identification section 153, the recording area forming section 154, the recording area monitoring section 155, the normal recording section 156, and the loop recording section 157, all of which pertain to the first embodiment. The recorder of the sixth embodiment implements normal recording and loop recording by means of only the AV stream file 46. The additional area forming section 658 corresponds to the additional area forming section 258 of the second embodiment. Namely, the recorder of the sixth embodiment replaces two AV stream files of the second embodiment (the first and second AV stream files 44 and 45) with the single AV stream file 46.

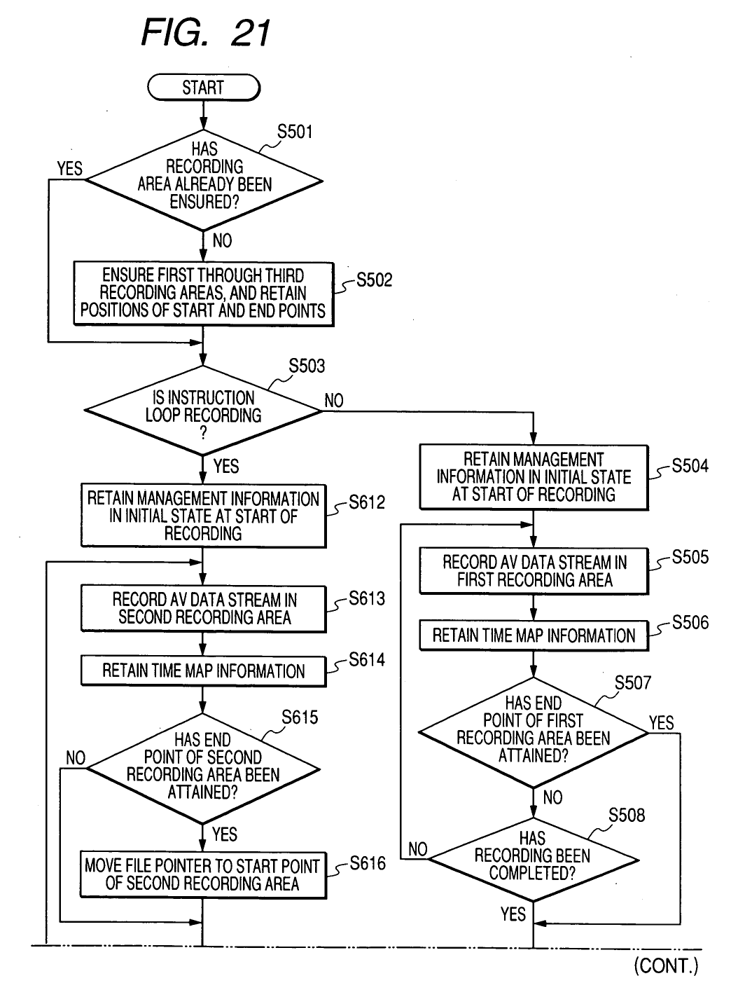

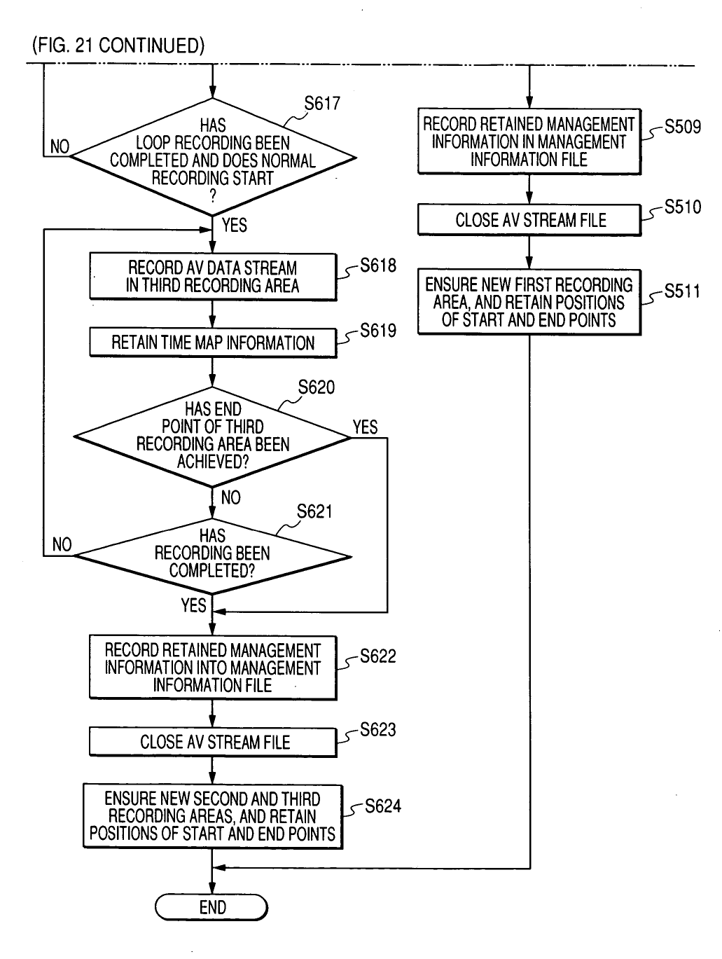

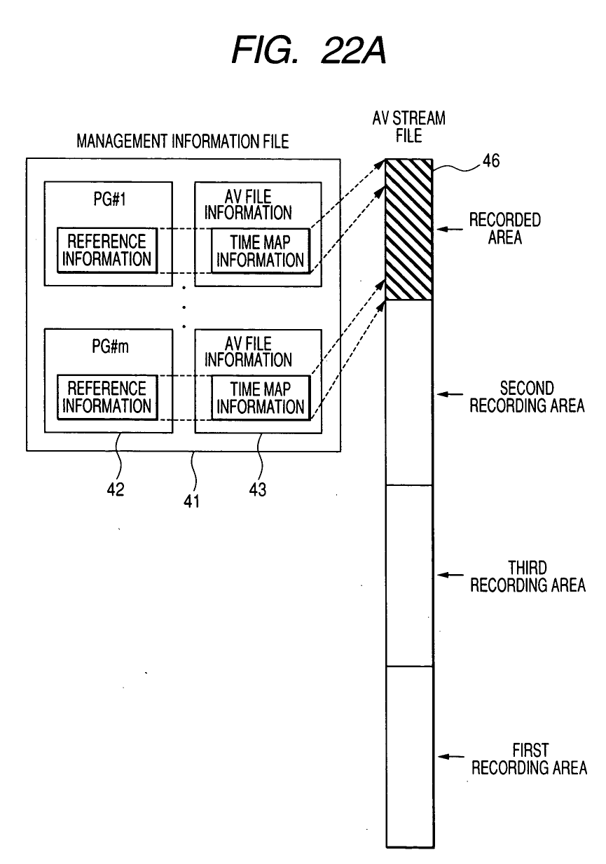

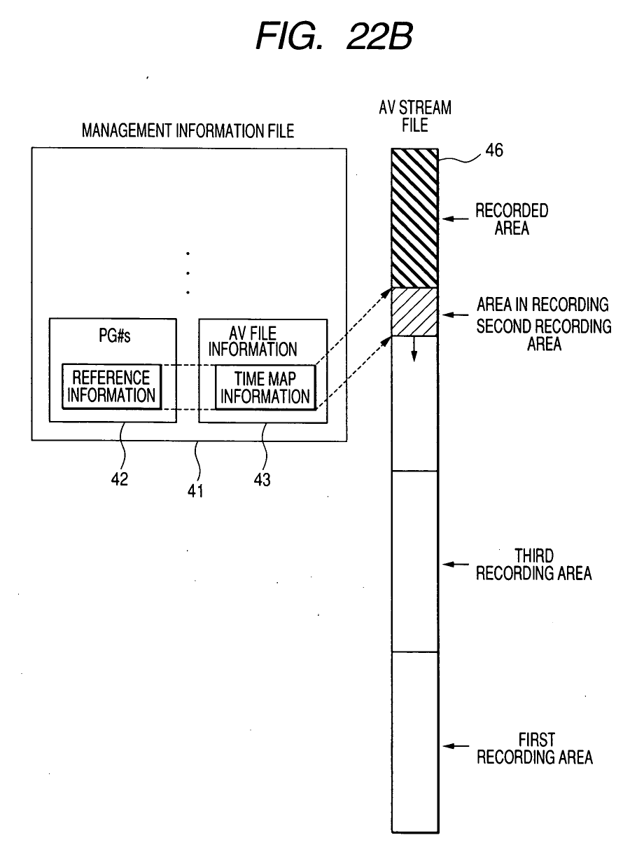

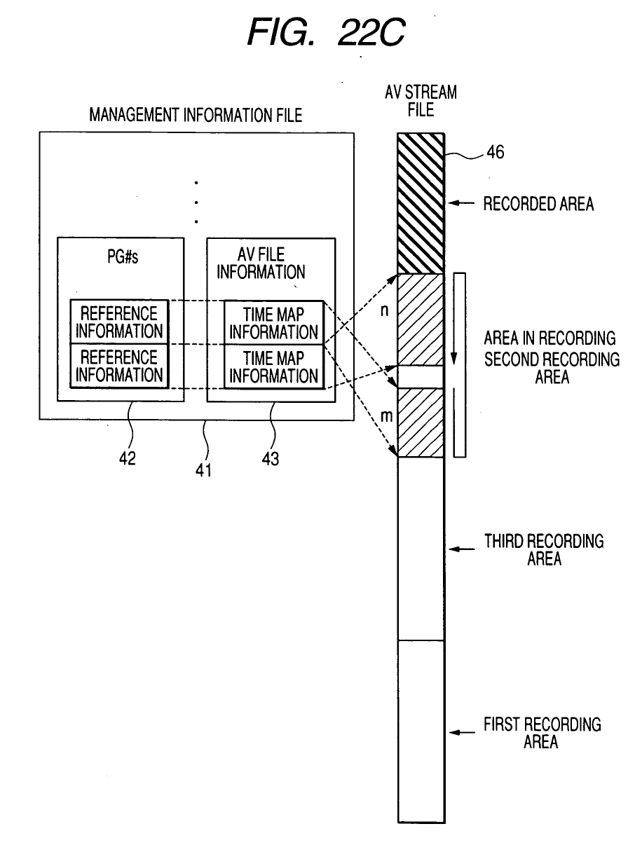

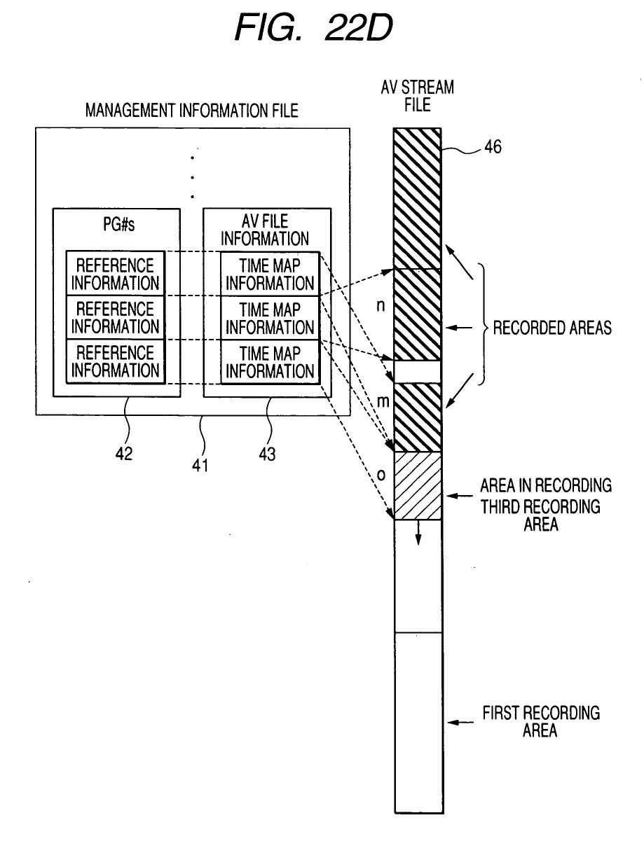

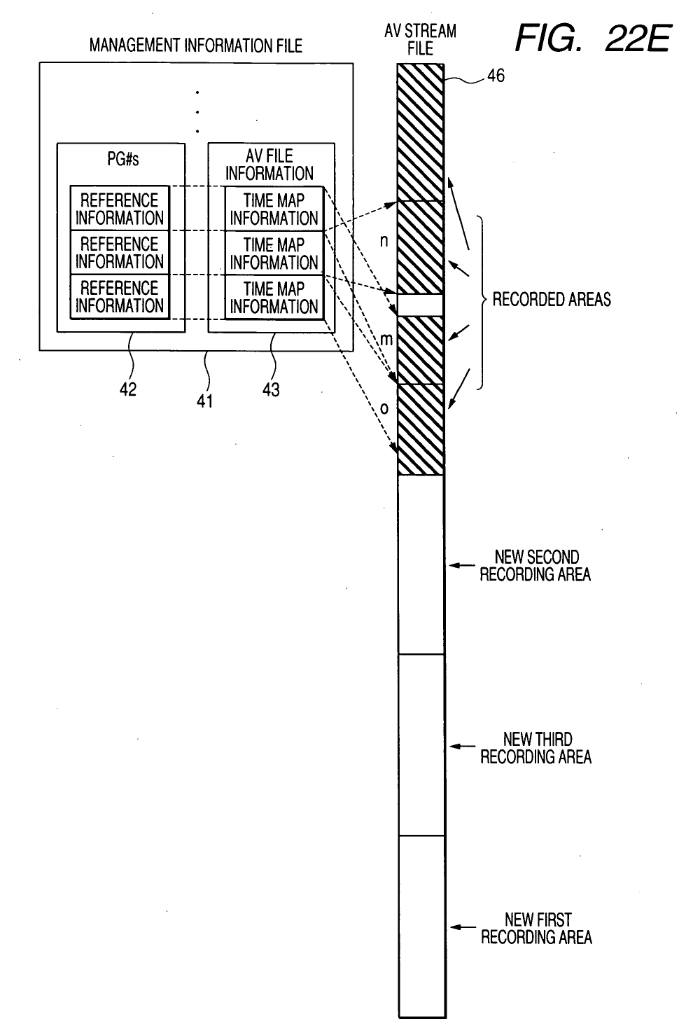

By reference to FIGS. 21 and 22A to 22E, operation of the recorder of the present embodiment will now be described. FIG. 21 is an exemplary flowchart showing operation of the recorder of the present embodiment, and FIGS. 22A to 22E are exemplary schematic diagrams showing recording operation performed during loop recording of the present embodiment.

First, FIG. 22A shows the management information 41 and an AV stream file 46, all of which are in an initial state. In the AV stream file 46, a second recording area for loop recording is ensured at a position continuing from the recorded area. Meanwhile, in the AV stream file 46, a third recording area for normal recording is ensured at a position continuing from a second recording area. In the embodiment shown in FIG. 22A, titles from PG#1 to PG#m have already been recorded as the program group information 42 recorded through normal recording, and the recorded area is formed in the AV stream file 46 (an area diagonally shaded by thick lines in FIG. 22A). These notations are omitted in subsequent descriptions for convenience.

In the recorder of the embodiment, the recording area monitoring section 655 monitors, at all times, whether or not the first through third recording areas are ensured (block S501 in FIG. 21). When the first through third recording areas are not ensured (NO in block S501), the recording area monitoring section 655 provides the recording area forming section 654 with an instruction for generating a first recording area for normal recording and second and third recording areas for loop recording. The recording area forming section 654 sequentially forms the second recording area, the third recording area, and the first recording area subsequent to the end point of the recorded area (block S502).

When the first through third recording areas have already been ensured (YES in block S501) or the recording area forming section 654 has formed the first through third recording areas, the recording scheme identification section 653 waits for an instruction from the user (block S503). When the key input section 35 has received the instruction from the user, the recording scheme identification section 653 determines whether or not the user's instruction is loop recording.

When the user's instruction is normal recording (NO in block S503), the recording scheme identification section 653 provides the normal recording section 656 with an instruction for normal recording. Normal recording of the present embodiment is identical with normal recording of the fifth embodiment (block S504 to block S511 in FIG. 17), and hence their explanations are omitted.

When the user's instruction received by way of the key input section 35 is loop recording (YES in block S503), the recording scheme identification section 653 provides the loop recording section 657 with an instruction for loop recording. Upon receipt of the instruction for loop recording, the loop recording section 657 generates management information 41 of initial state achieved at the start of recording, and retains the management information in internal memory (block S612). More specifically, the loop recording section 657 instructs the management information managing section 651 to generate information pertaining to the entire contents to be recorded from among the program group information 42, the reference information, and the AV file information 43. Upon receipt of the instruction, the management information managing section 651 receives, from the loop recording section 657, the logical address of the start point of the second recording area and the logical address of the end point of the same. Then, the management information managing section 651 sets the logical addresses as time map information in the AV file information 43.

When the management information 41 is generated, the loop recording section 657 records the video data and the audio data, which are sent from the PS encoder section 12 or the stream processor section 22, in the second recording area ensured in the AV data stream file 46 of the HDD section 14 (block S613). During the course of recording of the data into the second recording area, the management information managing section 651 generates, from moment to moment, time map information reflecting a progress in recording of the AV data stream, and records the generated time map information into the AV file information 43 of the memory (block S614).

FIG. 22B shows that contents are recorded in the second recording area of the AV stream file 46 through loop recording. In FIG. 22B, contents are recorded through loop recording under a new title PG#s. As shown in FIG. 22B, the AV data stream (as diagonally hatched by fine lines), which is to be recorded through loop recording, is recorded in the second recording area. The time map information, which is management information, corresponds to the AV data stream recorded in the second recording area.

During recording operation of the loop recording section 657, the recording area monitoring section 655 monitors the state of the second recording area that is being recorded by the loop recording section 657 (block S615). Specifically, the recording area monitoring section 655 determines a location up to which the AV data stream has been recorded in the recording medium (in the AV stream file 46), based on the time map information generated by the management information managing section 651. Then, the recording area monitoring section 655 compares the determined position with the retained position of the end point of the second recording area (the logical address on the recording medium), thereby determining whether or not the end point of the second recording area has been achieved.

When the recording point of the loop recording section 657 is not the end point of the second recording area (NO in block S615), the loop recording section 657 determines whether or not recording has been completed. When recording has not been completed (NO in block S617), recording operation is continued (block S613). When the loop recording section 657 does not determine that recording has been completed, loop recording operation is continued, and repeated overwriting is performed in the second recording area.

When the recording point of the loop recording section 657 is the end point of the second recording area (YES in block S615), the loop recording section 657 moves a file pointer (a recording point) of the AV stream file 46 to the position of the retained start point in the second recording area (a logical address on a recording medium) (block S616). Thereby, recording of a subsequent AV data stream is performed as overwrite-recording from the start point of the second recording area, whereby overwrite-recording by means of which the inside of ensured second recording area is reused frequently, i.e., loop recording, is performed. When a loopback has arisen in the second recording area, the position of the start point in time map information, where recording of contents in the AV data stream file 46 has started, must be adjusted. The management information managing section 651 shifts the position of the start point of a subsequent AV data stream backward in terms of time, by means of overwrite-recording.

FIG. 22C shows that a loopback has arisen in the second recording area during the course of loop recording of contents into the AV stream file 46. Among the AV data streams recorded through loop recording, an AV data stream “m” in the drawing is old in terms of time. Since the end of the AV data stream “m” has reached the end point of the second recording area, the file pointer of the AV stream file 46 is reset to the start point of the second recording area, whereby a subsequent portion is recorded as an AV data stream “n.” At that time, the AV data stream “n” is sequentially recorded in an overwriting manner from a position preceding the head of the AV data stream “m.” Accordingly, in association with overwrite-recording of the AV data stream “n,” the time map information indicating the AV data stream “m” shifts the position of the start point of the indicated AV data stream “m.”

In FIG. 22C, a point of connection between the AV data stream “m” and the AV data stream “n” is made discontiguous as a result of occurrence of a loopback. Therefore, pieces of time map information indicating respective AV data streams are provided separately. However, the present embodiment is not limited to such time map information. For instance, there may also be adopted a mechanism for pointing out the entire second recording area by means of one piece of time map information, and retaining information about the start point/end point of the recorded AV data stream separately, uniquely. In FIG. 22C, slight clearance exists between the last of the AV data stream “n” and the head of the AV data stream “m,” but the clearance is not always indispensable.

When the loop recording section 657 determines that recording has ended and that normal recording has started (YES in block S617), the loop recording section 657 has provided the management information managing section 651 with an instruction for completing loop recording and starting normal recording. Upon receipt of the instruction, the management information managing section 651 records the management information 41, which has been recorded thus far, in the HDD section 14 as a management information file. The loop recording section 657 shifts a file pointer to the start point of the third recording area, thereby continuously performing recording operation as normal recording (block S618). The management information managing section 651 receives, from the loop recording section 657, the logical address of the start point of the third recording area and the logical address of the end point of the same. Then, the management information managing section 651 sets, in the AV file information 43, new time map information corresponding to recording of data into the third recording area (block S619). The data recorded in the third recording area are recorded through normal recording and are not overwritten.

FIG. 22D shows the process of data being successively recorded in the AV stream file 46 through normal recording (continued normal recording) after completion of loop recording of data into the AV stream file 46. In FIG. 22D, an AV data stream, which is to be recorded in the third recording area through continued normal recording, is recorded. The time map information, which corresponds to the management information, indicates an AV data stream “o” recorded in the third recording area. The time map information indicating the AV data stream “o” recorded in the third recording area is included in a title PG#s which is identical with that of the time map information indicating the AV data streams “m” and “n” recorded in the second recording area through loop recording. Namely, the scene recorded through loop recording and a subsequent scene recorded through normal recording are grouped into one title.

During recording operation of the loop recording section 657, the recording area monitoring section 655 monitors the state of the third recording area that is being successively recorded by the loop recording section 657, and reports the state of the third recording area to the loop recording section 657 (block S620). Specifically, the recording area monitoring section 655 determines a location up to which the AV data stream has been recorded in the recording medium (in the AV stream file 46), based on the time map information generated by the management information managing section 651. Then, the recording area monitoring section 655 compares the determined location with the retained position of the end point of the third recording area (the logical address on the recording medium), thereby determining whether or not the end point of the third recording area has been achieved.

When the third recording point of the loop recording section 657 is not the end point of the third recording area (NO in block S620), the loop recording section 657 determines whether or not recording has been completed. When recording has not been completed (NO in block S621), recording operation is continued (block S618).

When the recording point of the loop recording section 657 is the end point of the third recording area (YES in block S620) or when the loop recording section 657 determined that recording has ended (YES in block S621), the loop recording section 657 provides the management information managing section 651 with an instruction concerning the completion of recording. Upon receipt of the instruction, the management information managing section 651 records the management information 41, which has been recorded thus far, in the HDD section 14 as a management information file (block S622). The loop recording section 657 completes recording operation, and the management information managing section 651 closes the AV stream file 46 (block S623). As a result of the management information managing section 651 having recorded the management information file, the recorded area in the AV stream file 46 is set as a recorded area in the program group information 42 (as diagonally hatched by thick lines in FIG. 22E), and the recorded area is brought under common management along with the recorded area of the AV stream file 46 that has been recorded through normal recording.

Subsequently, the recording area forming section 654 newly forms second and third recording areas, and passes the logical address of the start point of the second recording area, the logical address of the end point of the same, the logical address of the start point of the third recording area, and the logical address of the end point of the same to the management information managing section 651, thereby obviating the necessity of ensuring the recording area in block S502 in the next loop recording session.

FIG. 22E shows that loop recording of contents into the AV stream file 46 and normal recording performed subsequently to loop recording have ended. Since recording of the title PG #s has completed, a new second recording area is ensured in the AV stream file 46 for the next loop recording session. Further, a new third recording area used for normal recording performed continuously to completion of the next loop recording is ensured in the AV stream file 46. A new first recording area is ensured at a position subsequent to the third recording area for the next normal recording session.

FIG. 22E adopts a mechanism for indicating the recorded AV data stream “m” and the AV data stream “n” by means of separate pieces of time map information. However, as described previously, there may also be adopted a mechanism for pointing out these data streams by means of one piece of time map information, and retaining information about the start point/end point of the recorded AV data stream separately, uniquely. Moreover, the system may also indicates the entirety of the recorded AV data streams m, n, o by means of a single piece of time map information and retaining information about the start point/end point of the recorded AV data stream separately, uniquely. In addition, slight clearance existing between the last of the recorded AV data stream “n” and the head of the AV data stream “m,” but the clearance is not always indispensable.

As mentioned above, according to the recorder of the present embodiment, the management information managing section 651 manages the management information about normal recording and the management information about loop recording by means of the common program group information 42 and the AV file information 43. Hence, the management information can be provided to the user as program information without making a distinction between normal recording and loop recording.

Further, according to the recorder of the present embodiment, the loop recording section 657 instructs completion of recording, whereby loop-recorded data are stored as a recorded area serving as storage data. Hence, even in the case of loop-recorded data, the data can be recorded as storage data which is not subjected to overwriting.

Further, according to the recorder of the present embodiment, the recording area forming section 654 ensures a new second recording area for the next loop recording session and a new first recording area for a normal recording session after completion of loop recording. Hence, loop-recorded data are not subjected to overwriting and can be permanently stored as in the case of normal recording.

Although the embodiments of the present invention have been described thus far by reference to the drawings, the specifics of the present invention are not limited to those described herein. Needless to say, the present invention can be subjected to various modifications within the scope of the present invention.

As described in the embodiments, the contents recorded by loop recording are comprehensively managed by means of the same single management information as that employed for the contents recorded through normal recording, thereby implementing a loop recording technique for enabling the user to playback and watch contents later is implemented, which in turn enhances the user's convenience.

The contents recorded by loop recording are stored and comprehensively managed as in the case of the contents recorded through normal recording, thereby implementing a loop recording technique for enabling the user to playback and watch contents later, which in turn enhances the user's convenience.

Although the embodiments have been described chiefly by a hardware configuration, hardware may be implemented by software such as a computer program. Software may be stored in a computer-readable storage medium such as a flexible disk, or software may be solely transmitted (in the form of a program). In this case, the computer can read the software (a program) stored in the storage medium, or processing pertaining to the respective embodiments can be performed by downloading software from the LAN or the Internet (a server) and installing the downloaded software.

Specifically, the software (program) of the embodiment is not limited to a storage medium independent of a computer, and includes an article circulated by way of a medium such as a LAN and the Internet.

The storage medium may assume any storage pattern, so long as the storage medium can store a program and storage data and is computer-readable as in the case of, e.g., a magnetic disk, an optical disk (CD-ROM, CD-R, DVD, and the like), a magneto-optical disk (an MO and the like), semiconductor memory, and the like, in addition to the case of the flexible disk.

In accordance with an instruction from a program installed into a computer from the storage medium, MW (middle ware), such as an OS (Operating System) running in the computer, database management software, and network software may perform portions of respective operations of processing used for implementing the present embodiments.

Moreover, the storage medium is not limited to a medium independent of a computer, and includes a storage medium which is formed by downloading a program transmitted by way of an LAN or the Internet and storing or temporarily storing the downloaded program. The storage medium is not limited to one. Even when processing pertaining to the embodiments is performed from a plurality of mediums, the mediums are included in the recording medium of the present invention. The medium may assume any configuration.

In accordance with a program stored in the storage medium, the computer performs respective operations of processing of the present embodiments. The computer may assume a configuration where one piece of apparatus formed from a personal computer or a plurality of pieces of apparatus may be connected to a network.

The computer is not limited to a personal computer, The computer may includes an arithmetic processing unit or a microcomputer included in information processing equipment. That is, the computer is a generic name for equipment or devices which can implement functions of the present invention by means of a program.

The embodiments of the present invention can be applied to the electronic equipment manufacturing industry, and the like.

It is to be understood that the present invention is not limited to the specific embodiment described above and that the invention can be embodied with the elements modified without departing from the spirit and scope of the invention. The present invention can be embodied in various forms according to appropriate combinations of the elements disclosed in the embodiment described above. For example, some elements may be deleted from all elements shown in the embodiment. Further, the elements in different embodiments may be used appropriately in combination.

What is claimed is:

1. A recorder to record data into a storage medium, comprising:
a first area generation unit configured to generate a first recording area used for recording first data in the storage medium;
a second area generation unit configured to generate a second recording area in the storage medium, the second recording area used for repeatedly recording in an overwriting manner only second data, the second data being different from the first data and taken as an object of playback for a predetermined period;
a management information managing unit configured to record a management information file having management information about first data recorded in the first recording area in the storage medium; and
a management information edition unit configured to add management information about the second data into the management information file to allow the second data not to be overwritten in accordance with an instruction for storing the second data recorded in the second recording area, and record the management information into the storage medium.

2. The recorder according to claim 1, further comprising:
a third area generation unit configured to, upon receipt of a storage instruction, generate a third recording area used for continuously recording the second data having exceeded the volume of the second recording area in the storage medium.

3. The recorder according to claim 2, further comprising:
an area shift unit configured to shift the second data corresponding to added management information from the second recording area to the first recording area when the management information edition unit adds the management information about the second data to the management information file.

4. The recorder according to claim 2, wherein the first recording area and the second recording area are constructed in a common file system.

5. The recorder according to claim 1, further comprising:
an area shift unit configured to shift the second data corresponding to added management information from the second recording area to the first recording area when the management information edition unit adds the management information about the second data to the management information file.

6. The recorder according to claim 1, wherein the first recording area and the second recording area are constructed in a common file system.

7. A recorder comprising:
a first recording unit including a first recording area used for recording first data and a second recording area used for repeatedly overwriting only second data being different from the first data and are taken as an object of playback for a predetermined period;
a second recording unit recording a management information file including management information about the first data recorded in the first recording area;
a third recording unit recording the second data into the second recording area and performing continuous recording of the second data from the starting point of the second recording area when the second data are recorded to the end point of the second recording area; and
a management information edition unit configured to add the management information about the second data into the management information file to allow the second data not to be recorded in an overwriting manner, in accordance with an instruction for storing the second data recorded in the second recording area.

8. The recorder according to claim 7, wherein the first recording unit further includes a third recording area used for recording the second data subsequent to the second recording area upon receipt of an instruction for storage.

9. The recorder according to claim 8, further comprising:
an area shift unit configured to shift the second data corresponding to added management information from the second recording area to the first recording area when the management information edition unit adds the management information about the second data to the management information file.

10. The recorder according to claim 8, wherein the first recording area and the second recording area are constructed in a common file system.

11. The recorder according to claim 7, further comprising:
an area shift unit configured to shift the second data corresponding to added management information from the second recording area to the first recording area when the management information edition unit adds the management information about the second data to the management information file.

12. The recorder according to claim 7, wherein the first recording area and the second recording area are constructed in a common file system.

13. A recording method comprising:
recording into a predetermined recording area of a storage medium data taken as an object of playback for a predetermined period;
continuing recording of the data from a starting point of the predetermined recording area when recording has been performed up to an end point of the predetermined recording area;
setting management information to manage the recorded data as storage data, in accordance with a storage instruction for storing the recorded data; and
recording the data taken as the object of playback for a predetermined period into an area other than the area where the data for storage purpose are recorded.
